(19) United States
(12) Patent Application Publication
(10) Pub. No.: US 2012/0186489 A1
(43) Pub. Date: Jul. 26, 2012

(54) CELLULOSE ACYLATE FILM, RETARDATION FILM, POLARIZER AND LIQUID-CRYSTAL DISPLAY DEVICE

(75) Inventors: Nobutaka Fukagawa, Kanagawa (JP); Takahiro Ohno, Kanagawa (JP); Naoyuki Nishikawa, Kanagawa (JP); Toshihiro Kamada, Kanagawa (JP)

(73) Assignee: FUJIFILM CORPORATION, Tokyo (JP)

(21) Appl. No.: 13/499,182

(22) PCT Filed: Sep. 24, 2010
(86) PCT No.: PCT/JP2010/066558

§ 371 Date: Mar. 29, 2012

(30) Foreign Application Priority Data
Sep. 30, 2009 (JP) 2009-226432
Mar. 18, 2010 (JP) 2010-062180

(51) Int. Cl. C09D 101/02

(52) U.S. Cl. 106/162.9

(57) ABSTRACT

A cellulose acylate film containing a cellulose acylate and a carbohydrate derivative satisfying that the Clog P value thereof is from 0 to 5.5 and the maximum value of the molar extinction coefficient thereof in a wavelength range of from 230 nm to 700 nm is at most 50×10³, wherein the hydroxyl groups in the carbohydrate derivative are substituted with at least two types of substituents and at least one of the substituents has at least one aromatic ring, and wherein the carbohydrate derivative is contained in an amount of from 1 part by mass to 30 parts by mass relative to 100 parts by mass of the cellulose acylate therein has a low water content, capable of preventing the deterioration of polarizer when it is stuck to polarizer and aged in high-temperature and high-humidity environments, having good optical characteristics expressibility and having a low haze.

### TECHNICAL FIELD

The present invention relates to a cellulose acylate film, a retardation film, and to a polarizer and a liquid-crystal display device using the cellulose acylate film.

### BACKGROUND ART

Use of liquid-crystal display devices is expanding year by year as energy-saving and space-saving image display devices. Heretofore, one serious defect of liquid-crystal display devices is that the display image viewing angle dependence of the devices is large. Recently, however, wide viewing angle liquid-crystal display modes such as VA-mode and the like have become put into practical use, and accordingly, even in the market of televisions and others that require high-quality images, the demand for liquid-crystal display devices is rapidly expanding now.

The basic constitution of the liquid-crystal display device comprises a liquid-crystal cell with a polarizer arranged on both sides of the cell. The polarizer plays a role of transmitting a light polarized in a predetermined direction alone, and the performance of a liquid-crystal display device greatly depends on the performance of the polarizer therein. The polarizer generally comprises a polarizing element with a transparent protective film stuck to both sides thereof, in which the polarizing element is formed of a polyvinyl alcohol film or the like having adsorbed iodine or dye through alignment thereon. A cellulose acylate film of typically cellulose acetate has high transparency and can readily secure airtight adhesiveness to polyvinyl alcohol used as the polarizing element, and is widely used as a polarizer protective film.

It is known that arranging an optically biaxial retardation film between the polarizer and the liquid-crystal cell of a liquid-crystal display device can realize broader viewing angles, or that is, can improve the display characteristics of the device. As the retardation film, a cellulose acylate film is specifically noted that can express excellent optical performance, as concretely capable of expressing in-plane retardation Re (nm) and thickness-direction retardation Rth (nm), and such a cellulose acylate film is used as the retardation film in liquid-crystal display devices.

On the other hand, cellulose acylate film tends to absorb water as compared with any other synthetic polymer film, and therefore has a problem in that the film performance may often change depending on the environmental humidity change. As opposed to this, there has become investigated a method of adding a hydrophobic compound to a cellulose acylate film to thereby retard absorption of water by the film. As the additive, mainly proposed are structures having both a polar group moiety and a hydrophobic group moiety such as polyalcohol derivatives, polycarboxylic acid derivatives, etc. Patent Reference 1 discloses a method of adding a compound having a furanose structure or a pyranose structure to a cellulose acylate film to thereby reduce the optical change of the film depending on the environmental humidity change. Further, Patent Reference 2 discloses a method of adding a carbohydrate derivative to a cellulose acylate film.

With the recent tendency toward expanding use of liquid-crystal display devices, use of those devices for large-size and high-definition televisions and others has become expanded, and the requirements for the quality of polarizer, retardation film and polarizer protective film are much increasing. In particular, large-size and high-quality liquid-crystal display devices are desired to be used in various severer environments than before. From such viewpoints, the cellulose acylate film for use in liquid-crystal display devices is earnestly desired to satisfy both the requirement for enhanced resistance to humidity (that is, to further reduce the water content of the film and to make the film sufficiently protect polarizer when aged in high-temperature and high-humidity environments) and the requirement for enhanced optical characteristics (good retardation, low haze).

### CITATION LIST

### Patent References

Patent Reference 1: WO2007-125764
Patent Reference 2: WO2009-011229

### SUMMARY OF THE INVENTION

### Problems that the Invention is to Solve

The present inventors investigated the compounds described in the above-mentioned Patent References 1 and 2, and have known that, even though the compound described in these patent references is added, it is still difficult to satisfy all the requirements of water content reduction in the film, impartation of desired optical characteristics expressibility to the film, reduction of the haze of the film, and polarizer performance maintenance capability of the film when aged in high-temperature and high-humidity environments, and therefore further improvements are desired. In particular, when the film is aged in high-temperature and high-humidity environments, the polarizer performance maintenance capability thereof could not fully satisfy the level thereof recently required in the art of such that when the film is aged in an environment at 60° C. and at a relative humidity of 95% for 7 days, the cross transmittance change of the film at a wavelength of 410 nm is at most 0.05%.

An object of the invention is to provide a cellulose acylate film having a low water content, capable of preventing the deterioration of polarizer when it is stuck to polarizer and aged in high-temperature and high-humidity environments, having good optical characteristics expressibility and having a low haze. Another object is to provide a retardation film using the cellulose acylate film, and a polarizer and a liquid-crystal display device using the film.

### Means for Solving the Problems

For the purpose of solving the above-mentioned problems, the present inventors have assiduously studied and tried improving the compounds described in Patent References 1 and 2 from in all their aspects. As a result, the inventors have found that, when a carbohydrate derivative obtained by highly controlling the type of the substituent in a carbohydrate derivative as well as the degree of substitution of the derivative, and having a specific structure and specific physical properties is added, then a film improved in point of all the water content, the polarizer durability, the optical characteristics expressibility in a desired range and the haze thereof can be obtained. Concretely, the inventors have found that a carbohydrate derivative satisfying all the requirements of such that the hydroxyl groups therein are substituted with at least two types of substituents, at least one of the substituents has at least one aromatic ring, the Clog P value thereof is from 0 to 5.5, and the maximum value of the molar extinction coefficient thereof in a wavelength range of from 230 nm to 700 nm is at most 50×10³, can solve the above-mentioned problems. In particular, it has heretofore been considered in the art that, for reducing the water content of the film, the Clog P value of the compound to be added to the film must be planned to fall within a high value range, or that is, within a hydrophobic range; however, it is surprising that, as described above, a compound of which the Clog P value is planned to fall within a relatively low value range of from 0 to 5.5, or that is, within a relatively hydrophilic range can fully reduce the water content of the cellulose acylate film to which it is added. Consequently, it is unexpected from already-existing knowledge in the art that use of the compound of which the Clog P value falls within the range as above could provide a film improved in point of all the water content, the polarizer durability, the optical characteristics expressibility in a desired range and the haze thereof can be obtained.

Further, carbohydrate derivatives having such a specific structure and specific physical properties have heretofore been unknown. In addition, the inventors have found that carbohydrate derivatives not satisfying any one of the above-mentioned requirements could not solve the above-mentioned problems. Concretely, for example, the inventors have found that the exemplary compounds A-25, A-26, A-28 and A-29 in Patent Reference 2, which contain two different types of substituents of an aromatic ring-containing substituent and any other substituent but of which the Clog P value is more than 5.5, could not solve all the above-mentioned problems. In addition, the exemplary compounds A-5 to A-7 in Patent Reference 2, of which the Clog P value satisfies the range of from 0 to 5.5 but which contain only one type of an aromatic ring-containing substituent, could not also solve all the above-mentioned problems.

Specifically, the above-mentioned problems can be solved by the invention having the constitution mentioned below.

[1] A cellulose acylate film containing a cellulose acylate and a carbohydrate derivative satisfying the following conditions (a) and (b), wherein the hydroxyl groups in the carbohydrate derivative are substituted with at least two types of substituents and at least one of the substituents has at least one aromatic ring, and wherein the carbohydrate derivative is contained in an amount of from 1 part by mass to 30 parts by mass relative to 100 parts by mass of the cellulose acylate therein:
Condition (a): the Clog P value thereof is from 0 to 5.5,
Condition (b): the maximum value of the molar extinction coefficient thereof in a wavelength range of from 230 nm to 700 nm is at most 50×10³.
[2] The cellulose acylate film of [1], wherein the number of the hydroxyl groups contained in the carbohydrate derivative is at most 1 per monose unit of the carbohydrate derivative.
[3] The cellulose acylate film of [1] or [2], wherein the carbohydrate derivative has a structure represented by the following general formula (1):

(OH)p-G-(L1-R1)q(L2-R2)r General Formula (1)

(In the general formula (1), G represents a monose residue or a polyose residue; L1 and L2 each independently represent any of —O—, —CO—, —NR3-; R1, R2 and R3 each independently represent a hydrogen atom or a monovalent substituent; at least one of R1 and R2 has an aromatic ring. p indicates an integer of 0 or more; q and r each independently indicate an integer of 1 or more; p+q+r is equal to the number of the hydroxyl groups on the presumption that G is an unsubstituted sugar group having a cyclic acetal structure.)
[4] The cellulose acylate film of any one of [1] to [3], wherein the substituent of the hydroxyl group in the carbohydrate derivative is selected from a substituted or unsubstituted acyl group, a substituted or unsubstituted alkyl group, a substituted or unsubstituted aryl group, or a substituted or unsubstituted amino group.
[5] The cellulose acylate film of any one of [1] to [4], wherein the substituent of the hydroxyl group in the carbohydrate derivative contains at least one substituent not containing an aromatic ring.
[6] The cellulose acylate film of [5], wherein the substituent not containing an aromatic ring of the hydroxyl group in the carbohydrate derivative contains at least one acetyl group.
[7] The cellulose acylate film of any one of [1] to [6], wherein the substituent of the hydroxyl group in the carbohydrate derivative contains at least one benzyl group.
[8] The cellulose acylate film of any one of [1] to [7], wherein the substituent of the hydroxyl group in the carbohydrate derivative contains at least one phenylacetyl group.
[9] The cellulose acylate film of any one of [1] to [8], containing at least two types of carbohydrate derivatives differing in point of the substituent introduction ratio therein.
[10] A retardation film containing the cellulose acylate film of any one of [1] to [9].
[11] A polarizer containing the cellulose acylate film of any one of [1] to [9] or the retardation film of [10].
[12] A liquid-crystal display device containing the cellulose acylate film of any one of [1] to [9], the retardation film of [10] or the polarizer of [11].

### Advantage of the Invention

According to the invention, there is provided a cellulose acylate film having a low water content, capable of preventing the deterioration of polarizer when it is stuck to polarizer and aged in high-temperature and high-humidity environments, having good optical characteristics expressibility and having a low haze. Also provided are a retardation film using the cellulose acylate film, and a polarizer and a liquid-crystal display device using the film.

### BRIEF DESCRIPTION OF THE DRAWING

FIG. 1 This is a schematic view showing an example of the liquid-crystal display device of the invention.

### MODE FOR CARRYING OUT THE INVENTION

### [Cellulose Acylate Film]

The cellulose acylate film of the invention contains a cellulose acylate and a carbohydrate derivative satisfying the following conditions (a) and (b), wherein the hydroxyl groups in the carbohydrate derivative are substituted with at least two types of substituents and at least one of the substituents has at least one aromatic ring, and wherein the carbohydrate derivative is contained in an amount of from 1 part by mass to 30 parts by mass relative to 100 parts by mass of the cellulose acylate therein:

Condition (a): the Clog P value thereof is from 0 to 5.5,
Condition (b): the maximum value of the molar extinction coefficient thereof in a wavelength range of from 230 nm to 700 nm is at most 50×10³.

Adding the carbohydrate derivative to cellulose acylate film significantly lower the water content of the film not detracting from the optical characteristics expressibility of the film and not increasing the haze thereof.

Further, using the cellulose acylate film as a polarizer protective film greatly retards the deterioration of the polarizer performance in high-temperature and high-humidity environments.

The carbohydrate derivative and the production method for the cellulose acylate film are described in detail hereinunder in that order. In this description, “carbohydrate derivative usable singly in the invention” means the carbohydrate derivative satisfying the conditions (a) and (b), in which the hydroxyl groups are substituted with at least two types of substituents and at least one of the substituents has at least one aromatic ring. “Other carbohydrate derivative than the carbohydrate derivative usable singly in the invention” indicates a carbohydrate derivative not satisfying the condition (a), a carbohydrate derivative not satisfying the condition (b), a carbohydrate derivative in which the hydroxyl groups are not substituted with at least two substituents, or a carbohydrate derivative in which the substituents substituting for the hydroxyl groups all do not have an aromatic ring.

### <Carbohydrate Derivative>

The cellulose acylate film of the invention is characterized by containing the above-mentioned carbohydrate derivative. The details of the structure of the carbohydrate derivative for use in the invention are described below.

### (Hydrophilicity/Hydrophobicity of Carbohydrate Derivative)

Not adhering to any theory, it is important that, for the purpose of reducing the water content of the cellulose acylate film by the additive thereto, the additive exists near the cellulose acylate in the film and forms a predetermined hydrophobic site therein. Accordingly, the hydrophilicity/hydrophobicity of the additive is preferably controlled to fall within a specific range. Specifically, when the additive is too much hydrophobic, then the miscibility thereof with cellulose acylate would be insufficient and the proportion of the additive capable of existing around cellulose acylate would be small. On the other hand, when the additive is too much hydrophilic, then the additive itself may readily interact with water to rather increase the water content of the film.

### —Condition (a): ClogP Value—

The octanol-water distribution coefficient (log P value) can be measured by a flask permeation method described in Japan Industrial Standards (JIS) Z7260-107 (2000). The octanol-water distribution coefficient (log P value) may also be estimated, instead of the actual measurement, by a computational chemical method or an empirical method. As a computational method, known is use of Crippen's fragmentation method (J. Chem. Inf. Comput. Sci., 27, 21 (1987)), Viswanadhan's fragmentation method (J. Chem. Inf. Comput. Sci., 29, 163 (1989)), or Broto's fragmentation method (Eur. J. Med. Chem.-Chim. Theor., 19, 71 (1984)) and the like. In the invention, the Crippen's fragmentation method (J. Chem. Inf. Comput. Sci., 27, 21 (1987)) is used.

The Clog P value is a value of the common logarithm P of the distribution coefficient P between 1-octanol and water, as determined through computation. As the method and the software to be used in computation of the Clog P value, usable are known ones. In the invention, used is the CLOGP program incorporated in the system, PC Models by Daylight Chemical Information Systems.

In case where a compound shows different log P values depending on the measuring method or the computational method, the Crippen's fragmentation method is used for determining as to whether the compound is within the range of the invention.

The hydrophilicity/hydrophobicity of the hydrogen-bonding compound can be expressed by the octanol-water distribution coefficient (hereinafter this may be referred to as log P). The hydrophilicity/hydrophobicity of the hydrogen-bonding compound for use in the invention is characterized in that the Clog P value of the octanol-water distribution coefficient thereof is controlled to fall within a range of from 0 to 5.5. More preferably, the ClogP value of the hydrogen-bonding compound for use in the invention is from 1.0 to 5.0, most preferably from 2.0 to 4.5.

The film of the invention may contain at least two types of carbohydrate derivatives. Specifically, in case where the film of the invention contains the carbohydrate derivative usable singly in the invention (or that is, the carbohydrate derivative satisfying the above-mentioned conditions (a) and (b), in which the hydroxyl groups are substituted with at least two types of substituents and at least one of the substituents has at least one aromatic ring) in an amount of from 1 to 30 parts by mass, then the film of the invention may contain any other carbohydrate derivative than the carbohydrate derivative usable singly in the invention not contradictory to the sprit of the invention. Specifically, the film of the invention may contain the carbohydrate derivative described for comparative examples in Table 1 to Table 4 given below.

In case where the film of the invention contains at least two types of carbohydrate derivatives, preferably, the film contains at least two types of carbohydrate derivatives differing in point of the substituent introduction ratio therein from the viewpoint that the water content of the film can be significantly reduced not detracting from the optical characteristics expressibility of the film and not increasing the haze of the film. Use of the cellulose acylate film as a polarizer protective film is preferred as the film can significantly retards the deterioration of the performance of polarizer in high-temperature and high-humidity environments.

As described above, the carbohydrate derivative usable singly in the invention satisfies the conditions (a) and (b), in which the hydroxyl groups are substituted with at least two types of substituents and at least one of the substituents has at least one aromatic ring. Regarding the carbohydrate derivative of the type usable singly in the invention, those “differing in point of the substituent introduction ratio therein” mean the carbohydrate derivatives which are the same in point of the type of all the two or more substituents substituting for the hydroxyl groups of the constituent sugar of the carbohydrate derivative but which differ in point of the number of the substituents therein. For example, in case where the hydroxyl groups of the constituent sugar of carbohydrate derivatives are substituted with two types of substituents, a benzoyl group and an acetyl group, the carbohydrate derivatives differ in point of the number of the hydroxyl groups substituted with the benzoyl group and the number of the hydroxyl groups substituted with the acetyl group, and the carbohydrate derivatives do not have any other substituent than the benzoyl groups and the acetyl groups (however, the derivatives may have unsubstituted hydroxyl groups).

In case where the film of the invention contains one type of “the carbohydrate derivative usable singly in the invention” and one type of the “other carbohydrate derivative than the carbohydrate derivative usable singly in the invention” as combined therein, the film also exhibits the effect of the invention.

Preferably, however, the film of the invention contains at least two types of “carbohydrate derivatives usable singly in the invention” rather than the above-mentioned case. In this case of the film containing at least two types of “carbohydrate derivatives usable singly in the invention”, the film may or may not additionally contain, as combined therewith, the above-mentioned “other carbohydrate derivative than the carbohydrate derivative usable singly in the invention”. Above all, preferred is the film not containing the “other carbohydrate derivative than the carbohydrate derivative usable singly in the invention” from the viewpoint of the haze and the wavelength dispersion characteristics of retardation of the film.

The mode of difference in substituent introduction ratio is not specifically defined. For example, regarding carbohydrate derivatives where the hydroxyl groups of the pentafunctional constituent sugar are substituted with two types of substituents, a benzoyl group and an acetyl group, two or more different types of such carbohydrate derivatives may be combined and used here, in which the number of the benzoyl groups and the number of the acetyl groups each are an arbitrary number of from 0 to 5, and from 5 to 0, respectively. Regarding the preferred range of the mode of difference in substituent introduction, the following embodiment is preferred.

In the preferred embodiment, the ratio of the derivatives in which the number of the benzoyl groups is 2 and 3 is the highest, and the ratio thereof decreases in the order of benzoyl group number 2>benzoyl group number 1>benzoyl group number 0, and in the order of benzoyl group number 3>benzoyl group number 4>benzoyl group number 5.

In case where the film of the invention contains at least two types of carbohydrate derivatives, preferably, the mean value of the Clog P values of all the carbohydrate derivatives contained in the film of the invention is from 1.0 to 5.5, from the viewpoint of polarizer durability and haze, more preferably from 1.5 to 5.0, even more preferably from 2.0 to 4.5. Specifically, the mode of difference in substituent introduction ratio in the case where the film of the invention contains at least two types of carbohydrate derivatives is preferably such that the substituents are introduced into the derivatives so that the mean value of the Clog P values of the derivatives could fall within the above range.

In this description, the mean Clog P is computed according to the following formula:

Mean Clog P=ΣClog Pi·Wi

(In the formula, Clog Pi indicates the Clog P value of the i-th carbohydrate derivative, and Wi indicates the ratio by weight of the amount of the i-th carbohydrate derivative added to the film to the amount of all the carbohydrate derivatives added thereto.)

### (Absorption Characteristics of Carbohydrate Derivative)

Regarding the retardation film for use in liquid-crystal display devices such as VA, IPS or the like devices, it is known that the films having reversed wavelength dispersion characteristics of Re (of which Re is smaller on the shorter wavelength side) generally have excellent display performance in point of both the contrast and the color shift. Cellulose acylate have reversed wavelength dispersion characteristics of retardation, and are therefore preferred from this viewpoint. On the other hand, it is known that, when an additive having an absorption in a UV region of 200 nm or more is added to cellulose acylate film, then the wavelength dispersion characteristics of retardation of the film change to regular wavelength dispersion characteristics of retardation (Re of the film is larger on the shorter wavelength side). Not adhering to any theory, the present inventors have found that, when the molar extinction coefficient within a range of from 230 nm to 700 nm of the carbohydrate derivative is controlled to fall within a specific range or lower, then the film can prevent the deterioration of polarizer when stuck to polarizer and aged in high-temperature and high-humidity environments.

—Condition (b): Maximum Value of Molar Extinction Coefficient in a Wavelength Range of from 230 nm to 700 nm—

Consequently, of the carbohydrate derivative for use in the invention, the maximum value of the molar extinction coefficient (hereinafter this may be referred to as c) in a wavelength range of from 230 nm to 700 nm is at most 50×10³.

Preferably, the maximum value of the molar extinction coefficient in a wavelength range of from 230 nm to 700 nm of the carbohydrate derivative for use in the invention is at most 30×10³, more preferably at most 20×10³, most preferably at most 10×10³.

### (Molecular Weight)

Preferably, the molecular weight of the carbohydrate derivative for use in the invention is from 300 to 1500, more preferably from 350 to 1200, most preferably from 400 to 1000. Use of the carbohydrate derivative of which the molecular weight falls within the above range is preferred since the evaporation of the carbohydrate derivative in the film production process can be prevented and since the carbohydrate derivative can readily secure the miscibility thereof with cellulose acylate. The preferred range of the molecular weight of the other carbohydrate derivative than the carbohydrate derivative usable singly in the invention, which may be contained in the film of the invention, is also the same as the preferred range of the molecular weight of the carbohydrate derivative usable singly in the invention.

### (Structure of Carbohydrate Derivative)

The carbohydrate derivative for use in the invention has the structure to satisfy the above-mentioned conditions (a) and (b). Further, in the carbohydrate derivative for use in the invention, the hydroxyl groups are substituted with at least two substituents, and at least one of the substituents has a structure containing at least one aromatic ring. The structure of the carbohydrate derivative for use in the invention is described below.

—Structure to Satisfy the Condition (a)—

The structure to increase the Clog P value of the carbohydrate derivative for use in the invention is preferably a cyclic structure such as an aromatic ring or a cycloalkyl ring or the like, and especially preferably an aromatic ring. Consequently, the carbohydrate derivative for use in the invention is characterized in that at least one of the substituents therein has at least one aromatic ring. The derivative does not require any other indispensable structure for controlling the Clog P value thereof to fall within the range in the invention. The Clog P value of the derivative may be controlled to fall within the range in the invention by introducing the substituent having at least one aromatic ring and any other suitable substituent into the derivative at any suitable ratio.

—Structure to Satisfy the Condition (b)—

The structure of the carbohydrate derivative to make it have the above-mentioned absorption characteristic, or that is, to make the maximum value of the molar extinction coefficient in a wavelength range of from 230 nm to 700 nm of the derivative at most 30×10³ is not specifically defined. For this, for example, preferred is the structure mentioned below.

As the first preferred structure of the carbohydrate derivative for use in the invention to satisfy the above-mentioned absorption characteristics, there is mentioned a carbohydrate derivative that contains a substituent having an aromatic ring not conjugated with a functional group having a double bond (carbonyl group, etc.). In the first structure, preferred examples of the substituent having an aromatic ring not conjugated with a functional group having a double bond include a benzyl group, a phenylacetyl group, etc.

On the other hand, as the second preferred structure of the carbohydrate derivative for use in the invention to satisfy the above-mentioned absorption characteristics, there is mentioned a carbohydrate derivative in which the degree of substitution with the substituent having an aromatic ring conjugated with a functional group having a double bond is controlled to be not more than a predetermined level. In the second structure, preferred examples of the substituent having an aromatic ring conjugated with a functional group having a double bond include, for example, a benzoyl group. In the carbohydrate derivative for use in the invention that has a benzoyl group as the substituent, preferably, the degree of substitution with the benzoyl group per monose unit in the carbohydrate derivative is at most 3, more preferably at most 2.

Of the above-mentioned first and second structures, preferably, the carbohydrate derivative for use in the invention has the first structure.

### —Substituent for Use in Carbohydrate Derivative—

In the carbohydrate derivative for use in the invention, the hydroxyl groups of the constituent sugar of the derivative are substituted with at least two types of substituents, in which at least one of the substituents has at least one aromatic ring.

Preferably, the carbohydrate derivative for use in the invention has a structure represented by the following general formula (1) including the substituents usable therein.

(OH)p-G-(L1-R1)q(L2-R2)r General Formula (1)

In the general formula (1), G represents a monose residue or a polyose residue; L1 and L2 each independently represent any of —O—, —CO—, —NR3-; R1, R2 and R3 each independently represent a hydrogen atom or a monovalent substituent; at least one of R1 and R2 has an aromatic ring. p indicates an integer of 0 or more; q and r each independently indicate an integer of 1 or more; p+q+r is equal to the number of the hydroxyl groups on the presumption that G is an unsubstituted sugar group having a cyclic acetal structure.

The preferred range of G is the same as the preferred range of the constituent sugar to be mentioned below.

L1 and L2 each are preferably —O— or —CO—, more preferably —O—. In case where L1 and L2 each are —O—, preferably, they each are a linking group derived from an ether bond or an ester bond, more preferably an ester bond-derived linking group.

In case where the formula has multiple L1's and L2's, then they may be the same or different.

Preferably, R1, R2 and R3 each are a monovalent substituent. In particular, in case where L1 and L2 each are —O— (or that is, in case where R1, R2 and R3 substitute for the hydroxyl groups in the carbohydrate derivative), preferably, R1, R2 and R3 each are selected from a substituted or unsubstituted acyl group, a substituted or unsubstituted aryl group, a substituted or unsubstituted alkyl group, or a substituted or unsubstituted amino group, more preferably a substituted or unsubstituted acyl group, a substituted or unsubstituted alkyl group, or a substituted or unsubstituted aryl group, even more preferably an unsubstituted acyl group, a substituted or unsubstituted alkyl group, or an unsubstituted aryl group.

In case where the compound has multiple R1's, R2's and R3's, they may be the same or different.

p indicates an integer of 0 or more, and its preferred range is the same as the preferred range of the number of the hydroxyl groups per monose unit to be mentioned below.

q and r each independently indicate an integer of 1 or more, and the preferred range thereof is not specifically defined so far as it is a range to satisfy the above-mentioned conditions (a) and (b).

p+q+r is equal to the number of the hydroxyl groups on the presumption that G is an unsubstituted sugar group having a cyclic acetal structure, and therefore the upper limit of p, q and r may be specifically determined in accordance with the structure of G.

Preferred examples of the substituent in the carbohydrate derivative include an alkyl group (preferably an alkyl group having from 1 to 22 carbon atoms, more preferably from 1 to 12 carbon atoms, even more preferably from 1 to 8 carbon atoms, for example, a methyl group, an ethyl group, a propyl group, a hydroxyethyl group, a hydroxypropyl group, a 2-cyanoethyl group, a benzyl group, etc.), an aryl group (preferably an aryl group having from 6 to 24 carbon atoms, more preferably from 6 to 18 carbon atoms, even more preferably from 6 to 12 carbon atoms, for example, a phenyl group, a naphthyl group), an acyl group (preferably an acyl group having from 1 to 22 carbon atoms, more preferably from 2 to 12 carbon atoms, even more preferably from 2 to 8 carbon atoms, for example, an acetyl group, a propionyl group, a butyryl group, a pentanoyl group, a hexanoyl group, an octanoyl group, a benzoyl group, a toluoyl group, a phthalyl group, etc.), an amide group (preferably an amide group having from 1 to 22 carbon atoms, more preferably from 2 to 12 carbon atoms, even more preferably from 2 to 8 carbon atoms, for example, a formamide group, an acetamide group, etc.), an imide group (preferably an amide group having from 4 to 22 carbon atoms, more preferably from 4 to 12 carbon atoms, even more preferably from 4 to 8 carbon atoms, for example, a succinimide group, a phthalimide group, etc.).

Of those, preferred are the substituents exemplified for the structure to satisfy the above-mentioned condition (b), as the substituent having at least one aromatic ring. In the invention, preferably, the substituent for the hydroxyl group in the carbohydrate derivative contains at least one benzyl group from the viewpoint of enhancing the durability to humidity of the film. Similarly in the invention, it is desirable that the substituent for the hydroxyl group in the carbohydrate derivative contains at least one phenylacetyl group from the viewpoint of enhancing the durability to humidity of the film.

The hydroxyl groups of the constituent sugar of the carbohydrate derivative are substituted with at least two types of substituents, and in the invention, preferably, the substituents for the hydroxyl groups in the carbohydrate derivative contain at least one substituent not containing an aromatic ring from the viewpoint of reducing the haze of the film.

As the substituent not containing an aromatic ring, there are mentioned, for example, an alkyl group, an acyl group, etc. Of those, preferred are an acetyl group, a propyl group and a t-butyl group. More preferably, the substituent for the hydroxyl group not containing an aromatic group in the carbohydrate derivative contains at least one acetyl group from the viewpoint of reducing the haze of the film.

—Number of Hydroxyl Groups Per Monose Unit—

The number of the hydroxyl group per monose unit (hereinafter this may be referred to as a hydroxyl group content ratio) in the carbohydrate derivative for use in the invention is preferably at most 1. Controlling the hydroxyl group content ratio to fall within the range is preferred since the sugar carbohydrate derivative may be prevented from moving into the adjacent polarizing element layer to break the PVA-iodine complex therein while aged under high temperature and high humidity condition, and therefore the polarizing element performance may be prevented from worsening in aging under high temperature and high humidity condition.

### —Constituent Sugar—

Preferably, the carbohydrate derivative for use in the invention is a derivative of carbohydrate that contains a monose or contains from 2 to 5 monose units, more preferably a derivative of carbohydrate containing a monose or two monose units.

The monose or polyose that preferably constitutes the carbohydrate derivative is characterized in that the substitutable groups in the molecule thereof (for example, a hydroxyl group, a carboxyl group, an amino group, a mercapto group, etc.) are substituted with at least two types of substituents, and at least one of the substituents is substituted with a substituent having at least one aromatic ring.

Examples of the monose or the carbohydrate containing from 2 to 10 monose units include, for example, erythrose, threose, ribose, arabinose, xylose, lyxose, arose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, maltopentaose, verbascose, maltohexaose, α-cyclodextrin, β-cyclodextrin, γ-cyclodextrin, ∈-cyclodextrin, xylitol, sorbitol, etc.

Preferred are ribose, arabinose, xylose, lyxose, glucose, fructose, mannose, galactose, trehalose, maltose, cellobiose, lactose, sucrose, sucralose, α-cyclodextrin, β-cyclodextrin, γ-cyclodextrin, δ-cyclodextrin, xylitol, sorbitol; more preferred are arabinose, xylose, glucose, fructose, mannose, galactose, maltose, cellobiose, sucrose, β-cyclodextrin, γ-cyclodextrin; and even more preferred are xylose, glucose, fructose, mannose, galactose, maltose, cellobiose, sucrose, xylitol, sorbitol.

### (Specific Examples of Carbohydrate Derivative)

Preferably, the carbohydrate derivative has a pyranose structure or a furanose structure, more preferably a pyranose structure alone (including a polyose structure having multiple pyranose structures).

Preferred examples of the carbohydrate derivative for use in the invention, and examples of the carbohydrate derivative not included in the invention are mentioned below. However, the carbohydrate derivatives usable in the invention are not limited to these. In the following structures, R each independently represent an arbitrary substituent, and plural R's may be the same or different.

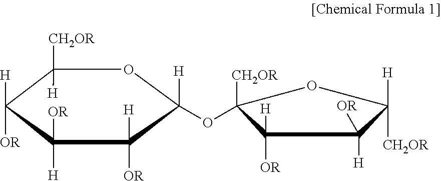

TABLE 1

| | | Substituent 1 | | Substituent 2 | | | |
|---|---|---|---|---|---|---|---|
| | | | degree of | | degree of | | Molecular |
| Note | Compound | type | substitution | type | substitution | ClogP | Weight |
| Invention | 101 | acetyl | 7 | benzyl | 1 | 2.9 | 727 |
| Invention | 102 | acetyl | 6 | benzyl | 2 | 4.4 | 775 |
| Invention | 103 | acetyl | 7 | benzoyl | 1 | 3.0 | 741 |
| Invention | 104 | acetyl | 6 | benzoyl | 2 | 4.5 | 802 |
| Comparative | 105 | benzyl | 2 | none | 0 | 0.6 | 523 |
| Comparative | 106 | benzyl | 3 | none | 0 | 2.5 | 613 |
| Comparative | 107 | benzyl | 4 | none | 0 | 4.3 | 702 |
| Invention | 108 | acetyl | 7 | phenylacetyl | 1 | 2.7 | 771 |
| Invention | 109 | acetyl | 6 | phenylacetyl | 2 | 4.4 | 847 |

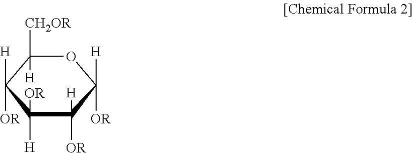

TABLE 2

| | | Substituent 1 | | Substituent 2 | | | |
|---|---|---|---|---|---|---|---|
| | | | degree of | | degree of | | Molecular |
| Note | Compound | type | substitution | type | substitution | ClogP | Weight |
| Invention | 201 | acetyl | 4 | benzoyl | 1 | 2.2 | 468 |
| Invention | 202 | acetyl | 3 | benzoyl | 2 | 3.9 | 514 |
| Invention | 203 | acetyl | 2 | benzoyl | 3 | 5.4 | 577 |
| Invention | 204 | acetyl | 4 | benzyl | 1 | 2.1 | 454 |
| Invention | 205 | acetyl | 3 | benzyl | 2 | 3.8 | 489 |
| Invention | 206 | acetyl | 2 | benzyl | 3 | 5.4 | 535 |
| Invention | 207 | acetyl | 4 | phenylacetyl | 1 | 2.2 | 466 |
| Invention | 208 | acetyl | 3 | phenylacetyl | 2 | 3.8 | 543 |
| Invention | 209 | acetyl | 2 | phenylacetyl | 3 | 5.5 | 619 |
| Comparative | 210 | phenylacetyl | 1 | none | 0 | −0.3 | 298 |
| Comparative | 211 | phenylacetyl | 2 | none | 0 | 2.0 | 416 |
| Comparative | 212 | phenylacetyl | 3 | none | 0 | 3.8 | 535 |
| Comparative | 213 | phenylacetyl | 4 | none | 0 | 6.2 | 654 |
| Comparative | 214 | acetyl | 1 | benzoyl | 4 | 6.36 | 639 |
| Comparative | 215 | acetyl | 0 | benzoyl | 5 | 8.26 | 701 |

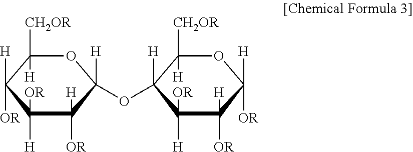

TABLE 3

| | | Substituent 1 | | Substituent 2 | | | |
|---|---|---|---|---|---|---|---|
| | | | degree of | | degree of | | Molecular |
| Note | Compound | type | substitution | type | substitution | ClogP | Weight |
| Invention | 301 | acetyl | 6 | benzoyl | 2 | 4.5 | 803 |
| Invention | 302 | acetyl | 6 | benzyl | 2 | 4.2 | 775 |
| Invention | 303 | acetyl | 6 | phenylacetyl | 2 | 4.3 | 831 |
| Comparative | 304 | benzoyl | 2 | none | 0 | 0.2 | 551 |
| Comparative | 305 | benzyl | 2 | none | 0 | 0.0 | 522 |
| Comparative | 306 | phenylacetyl | 2 | none | 0 | 0.0 | 579 |

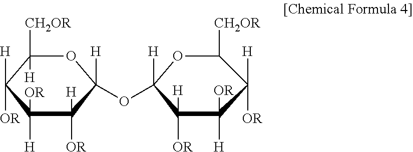

TABLE 4

| | | Substituent 1 | | Substituent 2 | | | |
|---|---|---|---|---|---|---|---|
| | | | degree of | | degree of | | Molecular |
| Note | Compound | type | substitution | type | substitution | ClogP | Weight |
| Invention | 401 | acetyl | 6 | benzoyl | 2 | 4.5 | 803 |
| Invention | 402 | acetyl | 6 | benzyl | 2 | 4.2 | 775 |
| Invention | 403 | acetyl | 6 | phenylacetyl | 2 | 4.3 | 831 |
| Comparative | 404 | benzoyl | 2 | none | 0 | 0.7 | 551 |
| Comparative | 405 | benzyl | 2 | none | 0 | 0.4 | 523 |
| Comparative | 406 | phenyl ester | 2 | none | 0 | 0.5 | 579 |

### (Getting Method)

Regarding the getting method for the carbohydrate derivative-base hydrophobizing agent, commercial products thereof are available from Tokyo Chemical, Aldrich, etc.; or commercial carbohydrates may be processed according to known ester derivative production methods (for example, according to the method described in JP-A 8-245678) to give the intended carbohydrate derivative-base hydrophobizing agents.

### (Amount to be Added)

The amount to be added of the carbohydrate derivative satisfying both the condition (a) and the condition (b) (carbohydrate usable singly in the invention) is from 1 to 30 parts by mass relative to 100 parts by mass of cellulose acylate. When the amount is at least 1% by mass, then the additive can readily attain the effect of improving polarizer durability; and when at most 30% by mass, then the additive may hardly bleed out. More preferably, the amount to be added is from 1 to 20 parts by mass relative to 100 parts by mass of cellulose acylate, even more preferably from 2 to 15 parts by mass, still more preferably from 5 to 12 parts by mass.

In case where the film of the invention contains any other carbohydrate derivative than the carbohydrate derivative usable singly in the invention, the preferred amount to be added of all those carbohydrate derivatives is the same as the preferred range of the amount to be added of the carbohydrate derivative usable singly in the invention.

Preferably, the ratio of the carbohydrate derivative usable singly in the invention to the total amount of all the carbohydrate derivatives contained in the film of the invention is from 50 to 100% by mass, more preferably from 70 to 100% by mass, even more preferably 100% by mass, or that is, it is desirable that all the carbohydrate derivatives contained in the film of the invention are the carbohydrate derivatives usable singly in the invention.

In case where the film of the invention contains two or more types of carbohydrate derivatives, preferably, the ratio (by mass) of the amount of the carbohydrate derivative usable singly in the invention to the amount of the other carbohydrate derivative than the carbohydrate derivative usable singly in the invention is from 50/50 to 100/0, more preferably from 60/40 to 100/0, even more preferably from 70/30 to 100/0.

The timing when the carbohydrate derivative is added to the cellulose acylate film is not specifically defined so far as the derivative could be added before film formation. For example, the derivative may be mixed with cellulose acylate in production of the cellulose acylate or in preparation of dope.

### <Cellulose Acylate>

The cellulose acylate for use in the invention is described in detail hereinunder.

The degree of substitution in cellulose acylate means the ratio of acylation of three hydroxyl groups existing in the constitutive unit of cellulose ((β)-1,4-glycoside-bonding glucose). The degree of substitution (degree of acylation) may be computed by determining the bonding fatty acid amount per the constitutive unit mass of cellulose. In the invention, the degree of substitution of cellulose may be computed as follows: The substituted cellulose is dissolved in a solvent such as deuterium-substituted dimethyl sulfoxide or the like, and analyzed for the 13C-NMR spectrum thereof. The degree of substitution may be computed from the peak intensity ratio of the carbonyl carbon in the acyl group. The remaining hydroxyl group in the cellulose acylate is substituted with any other acyl group than the acyl group that the cellulose acylate itself has, and then determined through 13C-NMR analysis. The details of the measurement method are described by Tezuka et al. (Carbohydrate, Res., 273 (1995) 83-91).

Preferably, the cellulose acylate for use in the invention has a degree of acylation of from 1.50 to 2.98, more preferably from 2.00 to 2.97.

The acyl group in the cellulose acylate for use in the invention is preferably an acetyl group, a propionyl group or a butyryl group.

A mixed fatty acid ester having two or more different acyl groups is also preferably used for the cellulose acylate in the invention. In this case, the acyl groups are preferably an acetyl group and an acyl group having 3 or 4 carbon atoms. Also preferably, the degree of substitution with acetyl group is less than 2.5, more preferably less than 1.9.

In the invention, two types of cellulose acylates that differ in the substituent and/or the degree of substitution therein may be used as combined or mixed; or films composed of multiple layers of different cellulose acylates may be formed according to a co-casting method or the like to be mentioned below.

The mixed acid ester having a fatty acid acyl group and a substituted or unsubstituted aromatic acyl group, which is described in JP-A 2008-20896, [0023] to [0038], is also preferred for use in the invention.

Preferably, the cellulose acylate for use in the invention has a mass-average degree of polymerization of from 250 to 800, more preferably a mass-average degree of polymerization of from 300 to 600. The cellulose acylate for use in the invention preferably has a number-average molecular weight of from 70000 to 230000, more preferably a number-average molecular weight of from 75000 to 230000, most preferably a number-average molecular weight of from 78000 to 120000.

The cellulose acylate for use in the invention may be produced using an acid anhydride or an acid chloride as the acylating agent. In case where the acylating agent is an acid anhydride, an organic acid (for example, acetic acid) or methylene chloride is used as the reaction solvent. As the catalyst, a protic catalyst such as sulfuric acid may be used. In case where the acylating agent is an acid chloride, a basic compound may be used as the catalyst. A most popular production method on an industrial scale comprises esterifying cellulose with a mixed organic acid component containing an organic acid (acetic acid, propionic acid, butyric acid) or an acid anhydride thereof (acetic anhydride, propionic anhydride, butyric anhydride) corresponding to an acetyl group and other acyl group, thereby producing a cellulose ester.

In the above method, cellulose such as cotton linter or wood pulp is, in many cases, activated with an organic acid such as acetic acid and then esterified with a mixed liquid of the above-mentioned organic acid component in the presence of a sulfuric acid catalyst. The organic acid anhydride component is used generally in an excessive amount over the amount of the hydroxyl group existing in cellulose. In the esterification treatment, hydrolysis reaction (depolymerization reaction) of the cellulose main chain ((β)-1,4-glycoside bond) occurs along with the esterification reaction. When the hydrolysis reaction of the main chain goes on, then the degree of polymerization of the cellulose ester lowers, and the physical properties of the cellulose ester film to be produced worsen. Accordingly, it is desirable that the reaction condition such as the reaction temperature is determined in consideration of the degree of polymerization and the molecular weight of the cellulose ester to be obtained.

### <Production Method for Cellulose Acylate Film>

The cellulose acylate film of the invention can be produced according to a solvent casting method. In the solvent casting method, a solution (dope) prepared by dissolving a cellulose acylate in an organic solvent is used for film formation.

Preferably, the organic solvent contains a solvent selected from ethers having from 3 to 12 carbon atoms, ketones having from 3 to 12 carbon atoms, esters having from 3 to 12 carbon atoms, and halogenohydrocarbons having from 1 to 6 carbon atoms.

The ethers, the ketones and the esters may have a cyclic structure. A compound having at least any two functional groups (—O—, —CO— and —COO—) of the ethers, the ketones and the esters may also be used as the organic solvent. The organic solvent may have any other functional group such as an alcoholic hydroxyl group. In the organic solvent having at least two different types of functional groups, preferably, the number of the constitutive carbon atoms falls within the preferred range of the number of the constitutive carbon atoms of the solvent having any of the functional groups.

Examples of the ethers having from 3 to 12 carbon atoms include diisopropyl ether, dimethoxymethane, dimethoxyethane, 1,4-dioxane, 1,3-dioxolane, tetrahydrofuran, anisole and phenetol.

Examples of the ketones having from 3 to 12 carbon atoms include acetone, methyl ethyl ketone, diethyl ketone, diisopropyl ketone, cyclohexanone and methylcyclohexanone.

Examples of the esters having from 3 to 12 carbon atoms include ethyl formate, propyl formate, pentyl formate, methyl acetate, ethyl acetate and pentyl acetate.

Examples of the organic solvent having at least two types of functional groups include 2-ethoxyethyl acetate, 2-methoxyethanol and 2-butoxyethanol.

Preferably, the number of carbon atoms constituting the halogenohydrocarbon having from 1 to 6 carbon atoms is 1 or 2, most preferably 1. Preferably, the halogen of the halogenohydrocarbon is chlorine. The proportion of the hydrogen atoms substituted with halogen in the halogenohydrocarbon is preferably from 25 to 75 mol %, more preferably from 30 to 70 mol %, even more preferably from 35 to 65 mol %, most preferably from 40 to 60 mol %. Methylene chloride is a typical halogenohydrocarbon.

Two or more different types of organic solvents may be mixed for use herein.

The cellulose acylate solution (dope) may be prepared according to an ordinary method of processing at a temperature not lower than 0° C. (ordinary temperature or high temperature). The cellulose acylate solution may be prepared according to a method and an apparatus for dope preparation in an ordinary solvent casting method. In the ordinary method, preferably, a halogenohydrocarbon (especially methylene chloride) is used as the organic solvent.

The amount of the cellulose acylate in the cellulose acylate solution is so controlled that the cellulose acylate could be contained in the solution obtained in an amount of from 10 to 40% by mass. More preferably, the amount of the cellulose acylate is from 10 to 30% by mass. Any additive to be mentioned below may be added to the organic solvent (main solvent).

The cellulose acylate solution may be prepared by stirring a cellulose acylate and an organic solvent at an ordinary temperature (0 to 40° C.). A high-concentration solution may be stirred under pressure and under heat. Concretely, a cellulose acylate and an organic solvent are put into a pressure container and sealed up, and heated with stirring under pressure and under heat at a temperature not lower than the boiling point of the solvent under ordinary pressure at which, however, the solvent does not boil. The heating temperature is generally 40° C. or higher, preferably from 60 to 200° C., more preferably from 80 to 110° C.

The constitutive ingredients may be put into a chamber after previously roughly mixed. They may be put into a chamber sequentially. The chamber must be so designed that the contents could be stirred therein. An inert gas such as nitrogen gas or the like may be injected into the chamber for pressurization. If desired, the increase in the vapor pressure of the solvent by heating may be utilized. As the case may be, the chamber is sealed up and then the constitutive ingredients may be added thereto under pressure.

In case where the chamber is heated, preferably, an external heat source is used. For example, a jacket-type heating unit may be used. As the case may be, a plate pipe heater may be provided outside the chamber, in which a liquid may be circulated to heat the entire chamber.

Preferably, a stirring blade is provided inside the chamber for stirring. Preferably, the stirring blade has a length reaching around the wall of the chamber. Preferably, the end of the stirring blade is provided with a scraper for renewing the liquid film on the wall of the chamber.

The chamber may be provided with indicators such as pressure gauge, thermometer, etc. The ingredients are dissolved in a solvent in the chamber. The prepared dope may be taken out of the chamber after cooled, or after taken out, it may be cooled with a heat exchanger or the like.

The cellulose acylate solution may also be prepared according to a cooling dissolution method. The details of the cooling dissolution method are described in JP-A 2007-86748, [0115] to [0122], which may be herein incorporated by reference.

In the cooling dissolution method, a cellulose acylate can be dissolved even in an organic solvent in which, however, the cellulose acylate would be difficult to dissolve in an ordinary dissolution method. Another advantage of the cooling dissolution method is that, even in a solvent capable of dissolving a cellulose acylate in an ordinary dissolution method, a uniform solution of the cellulose acylate can be rapidly prepared according to the cooling dissolution method.

In the cooling dissolution method, first, a cellulose acylate is gradually added to an organic solvent at room temperature with stirring. Preferably, the amount of the cellulose acylate is so controlled that the cellulose acylate could be contained in an amount of from 10 to 40% by mass of the mixture. More preferably, the amount of the cellulose acylate is from 10 to 30% by mass. Further, any desired additive to be mentioned below may be previously added to the mixture.

Next, the mixture is cooled to −100 to −10° C. (preferably from −80 to −10° C., more preferably from −50 to −20° C., most preferably from −50 to −30° C.). Cooling the mixture may be attained, for example, in a dry ice/methanol bath (−75° C.) or in a cooled diethylene glycol solution (−30 to −20° C.). As cooled, the mixture of cellulose acylate and organic solvent is solidified.

Preferably, the cooling speed is not lower than 4° C./min, more preferably not lower than 8° C./min, most preferably not lower than 12° C./min. The cooling speed is preferably higher, however, the theoretical upper limit thereof is 10000° C./min, the technical upper limit thereof is 1000° C./min, and the practicable upper limit thereof is 100° C./min. The cooling speed is a value computed by dividing the difference between the temperature at which the cooling is started and the final cooling temperature by the time taken from the start of cooling to the final cooling temperature.

Further, when the cooled mixture is heated at 0 to 200° C. (preferably at 0 to 150° C., more preferably at 0 to 120° C., most preferably at 0 to 50° C.), then the cellulose acylate dissolves in the organic solvent. For heating, the system may be left at room temperature, or may be heated in a warm bath. Preferably, the heating speed is not lower than 4° C./min, more preferably not lower than 8° C./min, most preferably not lower than 12° C./min. The heating speed is preferably higher, however, theoretical upper limit thereof is 10000° C./min, the technical upper limit thereof is 1000° C./min, and the practicable upper limit thereof is 100° C./min. The heating speed is a value computed by dividing the difference between the temperature at which the heating is started and the final heating temperature by the time taken from the start of heating to the final heating temperature.

As in the above, a uniform cellulose acylate solution is obtained. In case where the dissolution is insufficient, the cooling and/or heating operation may be repeated. The matter as to whether or not the dissolution is satisfactory can be determined by merely visually observing the outward appearance of the solution.

In the cooling dissolution method, for preventing the solution from being contaminated with water owing to dew condensation in cooling, preferably used is a closed chamber. During the cooling/heating operation, the system may be pressurized in cooling and may be depressurized in heating, thereby shortening the dissolution time. For pressurization and depressurization, preferably used is a pressure chamber.

When a 20 mas. % solution of cellulose acetate (having a degree of acetylation of 60.9%, and a viscosity-average degree of polymerization of 299) prepared by dissolving the cellulose acetate in methyl acetate according to a cooling dissolution method is analyzed through differential scanning calorimetry (DSC), the solution has a pseudo-phase transition point between a sol state and a gel state at around 33° C., and at a temperature lower than the point, the solution is in a uniform gel state. Accordingly, it is desirable that the solution is kept at a temperature not lower than the pseudo-phase transition temperature thereof, preferably at a temperature of the gel phase transition temperature thereof plus 10° C. or so. However, the pseudo-phase transition point varies depending on the degree of acetylation and the viscosity-average degree of polymerization of the cellulose acetate, on the solution concentration and on the organic solvent used.

A cellulose acylate film is produced from the thus-prepared cellulose acylate solution (dope) according to a solvent casting method. Preferably, a retardation enhancer is added to the dope. The dope is cast onto a drum or a band, on which the solvent is evaporated away to form a film. Before cast, the dope concentration is preferably so controlled that the solid content of the dope could be from 18 to 35%. Preferably, the surface of the drum or the band is mirror-finished. Preferably, the dope is cast onto the drum or the band having a surface temperature of not higher than 10° C.

The drying method in the solvent casting method is described in U.S. Pat. Nos. 2,336,310, 2,367,603, 2,492,078, 2,492,977, 2,492,978, 2,607,704, 2,739,069 and 2,739,070; British Patent 640731 and 736892; JP-B 45-4554 and 49-5614; JP-A 60-176834, 60-203430 and 62-115035. The film on the band or the drum may be dried by applying thereto an air flow or an inert gas flow such as nitrogen or the like.

The formed film may be peeled from the drum or the band, and then dried with high-temperature air of which the temperature is successively varied from 100° C. to 160° C. to thereby remove the residual solvent through vaporization. The method is described in JP-B 5-17844. According to the method, the time from casting to peeling may be shortened. To carry out the method, the dope must be gelled at the surface temperature of the casting drum or band.

Using the prepared cellulose acylate solution (dope), two or more layers may be cast to form a film. In this case, preferably, the cellulose acylate film is formed according to a solvent casting method. The dope is cast onto a drum or a band, and the solvent is evaporated away to form a film thereon. Before cast, the dope concentration is preferably so controlled that the solid content of the dope could be from 10 to 40% by mass. Preferably, the surface of the drum or the band is mirror-finished.

In case where two or more multiple cellulose acylate solutions are cast, it is possible to cast such multiple cellulose acylate solutions. Via multiple casting mouths arranged at intervals in the support running direction, the cellulose acylate-containing solution may be cast and laminated to form a film. For this, for example, employable are the methods described in JP-A 61-158414, 1-122419 and 11-198285. The cellulose acylate solution may be cast via two casting mouths for film formation. For this, for example, employable are the methods described in JP-B 60-27562, JP-A 61-64724, 61-947245, 61-104813, 61-158413 and 6-134933. Also employable here is a casting method for cellulose acylate film, comprising enveloping a flow of a high-viscosity cellulose acylate solution with a low-viscosity cellulose acylate solution so as to simultaneously extrude out the high/low-viscosity cellulose acylate solutions, as in JP-A 56-162617.

Another method is employable here, in which two casting mouths are used for film formation, a film formed on a support through the first casting mouth is peeled, and another film is cast onto the support-facing side of the previously formed film by second casting thereon. For example, there may be mentioned the method described in JP-B 44-20235.

The same cellulose acylate solution may be cast, or two or more different types of cellulose acylate solutions may be used. In order to make the multiple cellulose acylate layers have various functions, cellulose acylate solutions corresponding to the functions may be extruded out via the respective casting mouths. Further in the invention, the cellulose acylate solution may be cast simultaneously with other functional layers (for example, adhesive layer, dye layer, antistatic layer, antihalation layer, UV absorbent layer, polarizing layer, etc.).

In use of already-existing single-layer liquids, a high-concentration and high-viscosity cellulose acylate solution must be extruded for forming a film having a desired thickness. In such a case, the stability of the cellulose acylate solution is poor and to give solids, thereby often causing various problems of fish eyes or planarity failures. For solving the problems, multiple cellulose acylate solutions are cast via casting mouths to thereby simultaneously extrude high-viscosity solutions onto a support, and as a result, not only an excellent film having a bettered surface planarity can be obtained but also use of such a thick cellulose acylate solution reduces the drying load and the film production speed can be thereby increased.

The cellulose acylate film may contain, as added thereto, an antiaging agent (for example, antioxidant, peroxide decomposing agent, radical inhibitor, metal inactivator, acid scavenger, amine, etc.). The antiaging agent is described in JP-A 3-199201, 5-1907073, 5-194789, 5-271471, 6-107854. The amount of the antiaging agent to be added is preferably from 0.01 to 1% by mass of the solution (dope) to be prepared, more preferably from 0.01 to 0.2% by mass. When the amount thereof is at least 0.01% by mass, the antiaging agent can favorably exhibit its effect; and when at most 1.0% by mass, then the antiaging agent hardly bleeds out on the surface of the film and is favorable. Especially preferred examples of the antiaging agent are butylated hydroxytoluene (BHT) and tribenzylamine (TBA).

Preferably, fine particles are added to the cellulose acylate film as a mat agent. As the fine particles usable in the invention, there may be mentioned silicon dioxide, titanium dioxide, aluminium oxide, zirconium oxide, calcium carbonate, talc, clay, calcined kaolin, calcined calcium silicate, calcium silicate hydrate, aluminium silicate, magnesium silicate and calcium phosphate. As the fine particles, preferred are those containing silicon as reducing the haze of the film, and more preferred is silicon dioxide. Preferably, fine particles of silicon dioxide have a primary mean particle size of at most 20 nm and an apparent specific gravity of at least 70 g/liter. More preferably, the apparent specific gravity of the fine particles is from 90 to 200 g/liter or more, even more preferably from 100 to 200 g/liter or more. Those having a larger apparent specific gravity are preferred as they may form a dispersion having a high concentration and they reduce the haze of the film and reduce the aggregates in the film.

The fine particles form secondary particles generally having a mean particle size of from 0.1 to 3.0 μm, and these fine particles are in the film mainly as aggregates of primary particles thereof and form irregularities having a height of from 0.1 to 3.0 μm on the film surface. Preferably, the secondary mean particle size is from 0.2 μm to 1.5 μm, more preferably from 0.4 μm to 1.2 μm, most preferably from 0.6 μm to 1.1 μm. Regarding the size of the primary and secondary particles, the particles in the film are observed with a scanning electronic microscope, and the diameter of the circle circumscribing around the particle is measured to be the particle size. 200 particles are observed in different sites, and their data are averaged to be the mean particle size.

As the fine particles of silicon dioxide, for example, usable are commercial products of Aerosil R972, R972V, R974, R812, 200, 200V, 300, R202, OX50 and TT600 (all by Nippon Aerosil). Fine particles of zirconium oxide are sold on the market as trade names of Aerosil R976 and R811 (by Nippon Aerosil), and these can be used here.

Of those, Aerosil 200V and Aerosil R972V are fine particles of silicon dioxide having a primary mean particle size of at most 20 nm and having an apparent specific gravity of at least 70 g/liter, and are especially preferred for use herein as significantly effective for lowering the friction factor of an optical film with keeping low turbidity of the film.

In the invention, for obtaining a cellulose acylate film that contains fine particles having a small secondary mean particle size, some methods may be employed in preparing a dispersion of fine particles. For example, there may be employed a method comprising previously preparing a dispersion of fine particles where a solvent and fine particles are stirred and mixed, then dissolving the fine particles dispersion in a small amount of a cellulose acylate solution separately prepared, with stirring, and thereafter mixing the resulting solution with a main solution of cellulose acylate (dope solution). The method is favorable in that the silicon dioxide fine particles are well dispersible and hardly reaggregate in the dispersion. Apart from this, also employable is another method comprising adding a small amount of cellulose ester to a solvent and dissolving it with stirring, then adding fine particles thereto and dispersing them with a disperser to prepare a fine particles-added liquid, and well mixing the fine particles-added liquid with a dope solution with an in-line mixer. The invention is not limited to these methods. Preferably, the concentration of silicon dioxide in dispersing silicon dioxide fine particles in a solvent by mixing therein is from 5 to 30% by mass, more preferably from 10 to 25% by mass, most preferably from 15 to 20% by mass. The dispersion concentration is preferably higher since the liquid turbidity could be low relative to the added amount, and the haze of the formed film could be low and the amount of the aggregates in the film could also be low. The amount of the mat agent fine particles to be in the final cellulose acylate dope solution is preferably from 0.01 to 1.0 g/m³, more preferably from 0.03 to 0.3 g/m³, most preferably from 0.08 to 0.16 g/m³.

Lower alcohols may be used as the solvent, for example, methyl alcohol, ethyl alcohol, propyl alcohol, isopropyl alcohol, butyl alcohol, etc. The other solvent than the lower alcohol is not specifically defined. Preferably, the solvent used in cellulose ester film formation is used.

The process from casting to post-drying may be carried out in an air atmosphere or in an inert gas atmosphere of nitrogen gas or the like. The winder to be used in producing the cellulose acylate film in the invention may be any ordinary one, and the film may be wound up according to a winding method of a constant tension method, a constant torque method, a taper tension method or a programmed tension control method where the internal stress is kept constant.

### (Stretching Treatment)

The cellulose acylate film of the invention may be stretched. After stretched, the cellulose acylate film may be given a desired retardation. The stretching direction of the cellulose acylate film may be any of the lateral direction or the machine direction of the film.

A lateral stretching method is described, for example, in JP-A 62-115035, 4-152125, 4-284211, 4-298310, 11-48271.

The film is stretched under heat. The film may be stretched in drying treatment, and when a solvent remains in the film, the stretching is effective. In machine-direction stretching, for example, the speed of the film conveying rollers may be so controlled that the film winding speed could be higher than the film peeling speed, whereby the film is stretched. In lateral stretching, the film may be conveyed while both sides of the film are held with a tenter and the tenter width is gradually broadened to thereby stretch the film. After dried, the film may be stretched with a stretcher (preferably in a mode of monoaxial stretching with a long stretcher).

Preferably, the cellulose acylate film of the invention is stretched at a temperature of from (Tg−5° C.) to (Tg+40° C.) where Tg means the glass transition temperature of the cellulose acylate film, more preferably from Tg to (Tg+35° C.), even more preferably from (Tg+5° C.) to (Tg+30° C.). When the film is a dry film, preferably, it is stretched at from 130° C. to 200° C.

In case where the film is stretched while the dope solvent still remains therein after casting, the film may be stretched at a temperature lower than the temperature at which the dry film is stretched, and in this case, preferably, the wet film is stretched at from 100° C. to 170° C.

The draw ratio in stretching the cellulose acylate film of the invention (the rate of elongation relative to the unstretched film) is preferably from 1% to 200%, more preferably from 5% to 150%. Especially preferably, the film is stretched by from 1% to 200% in the lateral direction, more preferably by from 5% to 150%, even more preferably by from 30 to 45%.

The drawing speed is preferably from 1%/min to 300%/min, more preferably from 10%/min to 300%/min, most preferably from 30%/min to 300%/min.

Preferably, the stretched cellulose acylate film of the invention is produced through a step of stretching the film being produced to a maximum draw ratio followed by keeping it at a draw ratio lower than the maximum draw ratio (hereinafter this may be referred to as “relaxation step”). Preferably, the draw ratio in the relaxation step is from 50% to 99% of the maximum draw ratio, more preferably from 70% to 97%, most preferably from 90% to 95%. Preferably, the time for the relaxation step is from 1 second to 120 seconds, more preferably from 5 seconds to 100 seconds.

The production method for the cellulose acylate film of the invention preferably comprises a shrinking step of shrinking the film being produced with holding it in the lateral direction.

In the production method including the stretching step of stretching the film in the lateral direction thereof and the shrinking step of shrinking the film in the film traveling direction (machine direction), the film may be shrunk in the machine direction by holding it with a pantograph-type or linear motor-type tenter and gradually narrowing the distance between the clips while the film is stretched in the lateral direction and is shrunk in the machine direction.

In the above-mentioned method, the stretching step and the shrinking step are attained at least partly at the same time.

As the stretching apparatus for stretching the film in any one direction of the machine direction or the lateral direction and simultaneously shrinking it in the other direction to thereby increase the thickness of the film, preferred for use herein is Ichikin's FITZ. The apparatus is described in JP-A 2001-38802.

The draw ratio in the stretching step and the shrinkage ratio in the shrinking step may be defined suitably depending on the intended in-plane retardation Re and thickness-direction retardation Rth of the film to be produced. Preferably, the draw ratio in the stretching step is at least 10% and the shrinkage ratio in the shrinking step is at least 5%.

More preferably, in the production step, the stretching step of stretching the film being produced by at least 10% in the lateral direction is combined with the shrinking step of shrinking the film by at least 5% in the machine direction with holding the film in the lateral direction thereof.

The shrinking ratio as referred to in the invention means the ratio of the length of the film shrunk in the shrinking direction to the length of the film not shrunk.

Preferably, the shrinkage ratio is from 5 to 40%, more preferably from 10 to 30%.

### <Properties of Cellulose Acylate Film>

### (Retardation)

The properties of the cellulose acylate film of the invention are described in detail hereinunder.

Preferably, the cellulose acylate film of the invention satisfies the relation of the following formulae (1) to (4):

0 nm≦Re<300 nm Formula (1)

−50 nm<Rth<400 nm Formula (2)

In the formula (1), Re is more preferably from 0 nm to 200 nm, more preferably from 0 nm to 150 nm.

In the formula (2), Rth is more preferably from −30 nm to 350 nm, more preferably from −10 nm to 300 nm.

In this description, Re(λ) and Rth(λ) each indicate the in-plane retardation and the thickness-direction retardation, respectively, at a wavelength λ. Unless otherwise specifically indicated in this description, Re and Rth are Re and Rth at a wavelength of 548 nm. Re(λ) of a film can be measured by applying to the film, a light having a wavelength of λ nm in the film normal direction, using KOBRA 21ADH or WR (by Oji Scientific Instruments).

In case where the film to be analyzed is expressed as a monoaxial or biaxial index ellipsoid, Rth(λ) thereof may be computed as follows:

With the in-plane slow axis (determined by KOBRA 21ADH or WR) taken as the tilt axis (rotation axis) of the film (in case where the film has no slow axis, the rotation axis of the film may be in any in-plane direction of the film), Re(λ) of the film is measured at 6 points in all thereof, from the normal direction of the film up to 50 degrees on one side relative to the normal direction thereof at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above, when the film has a direction in which the retardation thereof is zero at a certain tilt angle relative to the in-plane slow axis thereof in the normal direction taken as a rotation axis, the sign of the retardation value of the film at the tilt angle larger than that tilt angle is changed to negative prior to computation with KOBRA 21ADH or WR.

Apart from this, Rth may also be measured as follows: With the slow axis taken as the tilt axis (rotation axis) of the film (in case where the film has no slow axis, the rotation axis of the film may be in any in-plane direction of the film), the retardation is measured in any desired two tilt directions, and based on the thus-determined retardation data, the assumptive mean refractive index and the inputted film thickness, Rth is computed according to the following formulae (21) and (22).

$$\begin{matrix} [ Numerical Formula 1 ] & \\ Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & Formula ( 21 )\end{matrix}$$

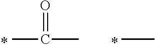

### Note:

Re(θ) means the retardation of the film in the direction tilted by an angle θ from the normal direction to the film. nx in the formula (21) means the in-plane refractive index of the film in the slow axis direction; ny means the in-plane refractive index of the film in the direction perpendicular to nx; nz means the refractive index in the direction perpendicular to nx and ny. d means the film thickness.

Rth=((nx+ny)/2−nz)×d Formula (22)

In case where the film to be analyzed is not expressed as a monoaxial or biaxial index ellipsoid, or that is, when the film does not have an optical axis, Rth(λ) thereof may be computed as follows:

With the in-plane slow axis (determined by KOBRA 21ADH or WR) taken as the tilt axis (rotation axis) of the film, Re(λ) of the film is measured at 11 points in all thereof, in a range of from −50 degrees to +50 degrees relative to the film normal direction thereof at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above measurement, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below. Cellulose acylate (1.48), cycloolefin polymer (1.52), polycarbonate (1.59), polymethyl methacrylate (1.49), polystyrene (1.59). With the assumptive mean refractive index and the film thickness inputted thereinto, Kobra 21ADH or WR can compute nx, ny and nz. From the thus-computed data nx, ny and nz, Nz=(nx−nz)/(nx−ny) is computed.

### (Thickness of Cellulose Acylate Film)

Preferably, the thickness of the cellulose acylate film of the invention is from 30 μm to 100 μm, more preferably from 30 μm to 80 μm, most preferably from 30 μm to 60 μm.

### (Glass Transition Temperature of Cellulose Acylate Film)

The glass transition temperature is measured according to the following method. A sample of the cellulose acylate film of the invention, 24 mm×36 mm is conditioned at 25° C. and at a relative humidity of 60% for at least 2 hours, and using a dynamic viscoelastometer (Vibron DVA-225, by ITK) at a sample length between grips of 20 mm, at a heating rate of 2° C./min in a temperature range of from 30° C. to 200° C. and at a frequency Hz. The storage modulus is plotted on the vertical logarithmic axis and the temperature on the linear horizontal axis. The glass transition temperature Tg is determined according to the method described in FIG. 3 of JIS K7121-1987, relative to the rapid decrease in the storage modulus observed in transition of the storage modulus from the solid region to the glass transition region.

### (Water Content of Cellulose Acylate Film)

Preferably, the equilibrium water content of the cellulose acylate film of the invention at 25° C. and at a relative humidity of 80% is from 0 to 5.0%, more preferably from 0.1 to 4.0%. When the equilibrium water content thereof is at most 5.0%, then the depression of the glass transition temperature of the cellulose acylate film owing to the plasticization effect thereof with water may be small and is therefore favorable from the viewpoint of preventing the polarization performance degradation under high-temperature and high-humidity environments.

The water content is measured according to a Karl-Fischer method, in which a sample of the cellulose acylate film of the invention, 7 mm×25 mm is analyzed with a moisture content meter and a sample drier (CA-03, VA-05, both by Mitsubishi Chemical). The amount of water (g) is divided by the weight of the sample (g) to determine the water content of the film.

### <Saponification Treatment>

Through alkali saponification treatment, the cellulose acylate film of the invention is given adhesiveness to a material of polarizing element such as polyvinyl alcohol, and can be used as a polarizer protective film. The saponification method is described in JP-A 2007-86748, [0211] and [0212]; and a method for producing the polarizing element for polarizer and the optical properties of polarizer are described in the same patent reference, [0213] to [0255]. Based on these descriptions, a polarizer can be produced where the film of the invention is used as a protective film.

For example, the cellulose acylate film of the invention is alkali-saponified preferably in a cycle of dipping the film surface in an alkali solution, then neutralizing it with an acid solution, and washing with water and drying it. The alkali solution includes a potassium hydroxide solution and a sodium hydroxide solution, in which the hydroxide ion concentration is preferably within a range of from 0.1 to 5.0 mol/L, more preferably from 0.5 to 4.0 mol/L. The alkali solution temperature is preferably within a range of from room temperature to 90° C., more preferably from 40 to 70° C.

### [Polarizer]

A polarizer generally comprises a polarizing element and two transparent protective films arranged on both sides thereof. As one protective film, the cellulose acylate film of the invention may be used. The other protective film may be an ordinary cellulose acylate film. The polarizing element includes an iodine-based polarizing element, a dye-based polarizing element that uses a dichroic dye, and a polyene-based polarizing element. The iodine-based polarizing element and the dye-based polarizing element are produced generally using a polyvinyl alcohol film. In case where the cellulose acylate film of the invention is used as a polarizer protective film, the method for producing the polarizer is not specifically defined, and the polarizer may be produced in an ordinary method. Employable is a method that comprises alkali-saponifying a formed cellulose acylate film and sticking it to both surfaces of a polarizing element produced by dipping and stretching a polyvinyl alcohol film in an iodine solution, using an aqueous, completely-saponified polyvinyl alcohol solution. In place of the alkali treatment, easy adhesion treatment may be employed, as in JP-A 6-94915, 6-118232. As the adhesive for sticking the processed surface of the protective film and the polarizing element, for example, usable are polyvinyl alcohol adhesives such as polyvinyl alcohol, polyvinyl butyral, etc.; and vinyl latexes of butyl acrylate, etc. The polarizer is composed of a polarizing element and a protective film to protect both sides thereof, in which a protect film may be stuck to one surface of the polarizer and a separate film may be stuck to the opposite surface thereof. The protect film and the separate film are used for the purpose of protecting the polarizer in shipping and in product inspection. In this case, the protect film is stuck for the purpose of protecting the surface of the polarizer, and is used on the opposite side of the polarizer to the side thereof to be stuck to a liquid-crystal plate. The separate film is used for the purpose of covering the adhesive layer of the polarizer to be stuck to a liquid-crystal plate, and is used on the side of the polarizer to be stuck to a liquid-crystal plate.

Regarding the method of sticking the cellulose acylate film of the invention to a polarizing element, preferably, the two are so arranged that the transmission axis of the polarizing element is substantially parallel to the slow axis of the cellulose acylate film of the invention.

In the liquid-crystal display device of the invention, preferably, the transmission axis of the polarizer is substantially parallel to the slow axis of the cellulose acylate film of the invention. The wording, “substantially parallel” as referred to herein means that the declination between the direction of the main refractive index nx of the cellulose acylate film of the invention and the direction of the transmission axis of the polarizer are both within a range of 5°, preferably within a range of 1°, more preferably within a range of 0.5°. In case where the declination is larger than 1°, then it is unfavorable since the polarizability of the polarizer lowers under cross-Nicol therefore causing light leakage.

The cross transmittance CT of the polarizer is measured with UV3100PC (by Shimadzu). The polarizer is analyzed within a range of from 380 nm to 780 nm. One sample is tested in the same manner for a total of 10 times, and the data are averaged.

In the polarizer durability test, (1) the polarizer alone and (2) a test sample prepared by sticking the polarizer to glass with an adhesive are tested in the manner mentioned below. The test of the polarizer alone (1) is as follows: Two polarizing elements are prepared and combined perpendicularly with the cellulose acylate film sandwiched therebetween, and two such samples are prepared. The test of the sample prepared by sticking the polarizer to glass with an adhesive (2) is as follows: The polarizer is stuck to glass in such a manner that the cellulose acylate film of the invention could face the glass side, and two such samples (about 5 cm×5 cm) are prepared. For measuring the cross transmittance thereof, the sample was so set that the film side thereof could face a light source. Two samples are separately analyzed, and the data are averaged to give the cross transmittance of the sample. In Examples of the invention given below, the test method (2) of the above-mentioned test methods (1) and (2) was employed.

Regarding the polarization performance, the preferred range of the cross transmission CT is CT≦2.0, more preferably CT≦1.3 (unit, %).

In the polarizer durability test, the variation of the found data is preferably smaller. Preferably, the polarizer of the invention satisfies that the variation of the cross transmittance of the polarizer statically kept at 60° C. and at a relative humidity of 95% for 7 days is 0.05% or less.

In this, the variation is a value computed by subtracting the measured value before the test from the measured value after the test.

When the polarizer satisfies the above-mentioned the variation of the cross transmittance, then it is favorable since the stability of the polarizer can be secured in long-term use or storage in high-temperature and high-humidity environments.

### <Functionalization of Polarizer>

The polarizer of the invention may be favorably used as a functionalized polarizer, as combined with an optical film having a functional layer, such as an antireflection film, a brightness-improving film, a hard coat layer, a front scattering layer, an antiglare layer or the like, for the purpose of improving the visibility of displays. The antireflection film, the brightness-improving film and other functional optical films as well as the hard coat layer, the front scattering layer and the antiglare layer for functionalization are described in JP-A 2007-86748, [0257] to [0276], and based on these descriptions, the functionalized polarizers may be produced.

### (Antireflection Film)

The polarizer of the invention may be used, as combined with an antireflection film. As the antireflection film, usable here is any of a film merely given a single layer of a low-refractivity material such as a fluoropolymer or the like and having a reflectivity of 1.5% or so, or a film utilizing multilayer interference of thin films and having a reflectivity of at most 1%. In the invention, preferred is use of a configuration produced by laminating a low-refractivity layer and at least one layer having a higher refractivity than that of the low-refractivity layer (that is, a high-refractivity layer, a middle-refractivity layer) on a transparent support. In addition, also preferred for use herein are the antireflection films described in Nitto Technical Report, Vol. 38, No. 1, May 2000, pp. 26-28, and in JP-A 2002-301783.

The layers satisfy the following relationship in point of the refractivity thereof.

Refractive index of high-refractivity layer>refractive index of middle-refractivity layer>refractive index of transparent support>refractive index of low-refractivity layer

As the transparent support for use in the antireflection film, preferably used is the same transparent polymer film as that to be used for the protective film for polarizing element mentioned above.

Preferably, the refractive index of the low-refractivity layer is from 1.20 to 1.55, more preferably from 1.30 to 1.50. Preferably, the low-refractivity layer is used as the outermost layer having abrasion resistance and fouling resistance. For enhancing the abrasion resistance of the layer, preferably used is a material of a silicone-containing compound having a silicone group or a fluorine-containing compound containing fluorine or the like to thereby impart lubricity to the surface of the layer.

As the fluorine-containing compound, for example, preferably used here are the compounds described in JP-A 9-222503, [0018] to [0026], JP-A 11-38202, [0019] to [0030], JP-A 2001-40284, [0027] to [0028], JP-A 2000-284102, etc.

As the silicone-containing compound, preferred are compounds having a polysiloxane structure; however, reactive silicones (for example, Silaplane by Chisso, and polysiloxane having a silanol group at both ends thereof (JP-A 11-258403)) and the like are also usable here. An organic metal compound such as a silane coupling agent and a specific, fluorohydrocarbon group-containing silane coupling agent may be cured through condensation in the presence of a catalyst (compounds described in JP-A 58-142958, 58-147483, 58-147484, 9-157582, 11-106704, 2000-117902, 2001-48590, 2002-53804, etc.).

Preferably, the low-refractivity layer may contain, as other additives than the above added thereto, a filler (for example, low-refractivity inorganic compounds having a primary particle size of from 1 to 150 nm, such as silicon dioxide (silica), fluorine-containing particles (magnesium fluoride, calcium fluoride, barium fluoride), etc.; organic fine particles described in JP-A 11-3820, [0020] to [0038], etc.), a silane coupling agent, a lubricant, a surfactant, etc.

The low-refractivity layer may be formed according to a vapor phase method (vacuum evaporation method, sputtering method, ion plating method, plasma CVD method, etc.); however, the layer is preferably formed according to a coating method as indispensable. As the coating method, preferred are a dip coating method, an air knife coating method, a curtain coating method, a roller coating method, a wire bar coating method, a gravure coating method, a microgravure coating method.

Preferably, the thickness of the low-refractivity layer is from 30 to 200 nm, more preferably from 50 to 150 nm, most preferably from 60 to 120 nm.

Preferably, the middle-refractivity layer and the high-refractivity layer each are so designed that ultrafine particles of a high-refractivity inorganic compound having a mean particle size of at most 100 nm are dispersed in the matrix material thereof. As the fine particles of a high-refractivity inorganic compound, preferably used here are inorganic compounds having a refractive index of at least 1.65, for example, oxides of Ti, Zn, Sb, Sn, Zr, Ce, Ta, La, In or the like, as well as composite oxides containing such metal atoms, etc.

The ultrafine particles may used in various embodiments where the particles are surface-treated with a surface-treating agent (e.g., silane coupling agent or the like as in JP-A 11-295503, 11-153703, 2000-9908; anionic compound or organic metal coupling agent as in JP-A 2001-310432), or the particles have a core/shell structure in which a high-refractivity particle is a core (for example, as in JP-A 2001-166104), or the particles are combined with a specific dispersant (for example, as in JP-A 11-153703, U.S. Pat. No. 6,210,858B1, JP-A 2002-2776069), etc.

As the matrix material, usable here are heretofore known thermoplastic resins, curable resin films, etc. Also usable are polyfunctional materials as in JP-A2000-47004, 2001-315242, 2001-31871, 2001-296401, etc.; curable films obtained from metal alkoxide compounds as in JP-A 2001-293818, etc.

Preferably, the refractive index of the high-refractivity layer is from 1.70 to 2.20. Preferably, the thickness of the high-refractivity layer is from 5 nm to 10 μm, more preferably from 10 nm to 1 μm.

The refractive index of the middle-refractivity layer is so controlled as to fall between the refractive index of the low-refractivity layer and the refractive index of the high-refractivity layer. Preferably, the refractive index of the middle-refractivity layer is from 1.50 to 1.70.

Preferably, the haze of the antireflection layer is at most 5%, more preferably at most 3%. Preferably, the strength of the film is on a level of H or more in the pencil hardness test according to JIS K5400, more preferably 2H or more, most preferably 3H or more.

### (Brightness-Improving Film)

The polarizer of the invention can be used, as combined with a brightness-improving film. The brightness-improving film has a function of separating a circularly-polarized light or a linearly-polarized light, and as arranged between polarizer and backlight, the film reflects or scatters one circularly-polarized light or linear-polarized light, backward to the backlight side. The polarization state of the re-reflected light from the backlight side is partly changed, and when again running toward the brightness-improving film and the polarizer, the light partly passes through it; and after repetition of the step, the light utilization ratio increases and the front brightness increases up to about 1.4 times. As the brightness-improving film, known is an anisotropic reflection-type film and an anisotropic scattering-type film, any of which can be combined with the polarizer of the invention.

As the anisotropic reflection-type film, known is a brightness-improving film of a type in which multiple monoaxially-stretched films and unstretched films are laminated several-fold to thereby increase the refractivity difference in the stretching direction and which therefore has refractivity anisotropy and transmittance anisotropy. Regarding the film of the type, known are multilayer-type films utilizing the principle of dielectric mirror (as in WO95/17691, WO95/17692, WO95/17699) and cholesteric liquid-crystal-based films (as in EP 606940A2, JP-A 8-271731). As the multilayer-type brightness-improving film utilizing the principle of dielectric mirror, DBEF-E, DBEF-D and DBEF-M (all by 3M) are preferably used in the invention; and as the cholesteric liquid-crystal-based brightness-improving film, NIPOCS (by Nitto Denko) is preferably used in the invention. For NIPOCS, referred to is Nitto Technical Report, Vol. 38, No. 1, May 2000, pp. 19-21.

Also preferred in the invention is a combined use with an anisotropic scattering-type brightness-improving film prepared by blending a positive intrinsic birefringent polymer and a negative intrinsic birefringent polymer followed by monoaxially stretching the film of the blend, as in WO97/32223, WO97/32224, WO97/32225, WO97/32226, and JP-A 9-274108, 11-174231. As the anisotropic scattering-type brightness-improving film, preferred is DRPF-H (by 3M).

### (Other Functional Optical Films)

Preferably, the polarizer of the invention is used, as combined with an functional optical film having a hard coat layer, a front scattering layer, an antiglare layer, a gas-barrier layer, a lubricant layer, an antistatic layer, an undercoat layer, a protective layer, etc. Also preferably, the functional layer is used, as mutually complexed in one and the same layer with the antireflection layer, the optical anisotropic layer or the like of the antireflection film mentioned above. The functional layer may be arranged on any one side of the polarizing element side of the polarizer or the side thereof opposite to the polarizing element side (the side nearer to the air-facing side), or on both sides thereof.

### (Hard Coat Layer)

Preferably, the polarizer of the invention is combined with a functional optical film, which comprises a transparent support and a hard coat layer formed on the surface of the support, for the purpose of imparting mechanical strength such as abrasion resistance or the like thereto. In case where the hard coat layer is applied to the above-mentioned antireflection film, preferably, the layer is provided between the transparent support and the high-refractivity layer.

Preferably, the hard coat layer is formed through crosslinking reaction or polymerization reaction of a curable compound by light and/or heat. As the curable functional group, preferred is a photopolymerizing functional group, or a hydrolyzable functional group-containing organic metal compound or an organic alkoxysilyl compound is preferred. As the specific constitutive composition for the hard coat layer, for example, preferably used here are those described in JP-A 2002-144913 and 2000-9908, WO00/46617, etc.

Preferably, the thickness of the hard coat layer is from 0.2 μm to 100 μm.

Preferably, the strength of the hard coat layer is on a level of at least H in the pencil hardness test according to JIS K5400, more preferably at least 2H, most preferably at least 3H. Also preferably, the abrasion loss of the test piece before and after the taper test according to JIS K5400 is smaller.

As the material to form the hard coat layer, usable are ethylenic unsaturated group-containing compounds, and ring-opening polymerizing group-containing compounds. One or more these compounds may be used here either singly or as combined. Preferred examples of the ethylenic unsaturated group-containing compounds are polyol polyacrylates such as ethylene glycol diacrylate, trimethylolpropane triacrylate, ditrimethylolpropane tetraacrylate, pentaerythritol triacrylate, pentaerythritol tetraacrylate, dipentaerythritol pentaacrylate, dipentaerythritol hexaacrylate, etc.; epoxy acrylates such as bisphenol A diglycidyl ether diacrylate, hexanediol diglycidyl ether diacrylate, etc.; urethane acrylates to be obtained through reaction of polyisocyanate and hydroxyl group-containing acrylate such as hydroxyethyl acrylate, etc. As commercial products, there may be mentioned EB-600, EB-40, EB-140, EB-1150, EB-1290K, IRR214, EB-2220, TMPTA, TMPTMA (all by Daicel UCB), UV-6300, UV-1700B (both by Nippon Gohsei), etc.

Preferred examples of the ring-opening polymerizing group-containing compounds are glycidyl ethers such as ethylene glycol diglycidyl ether, bisphenol A diglycidyl ether, trimethylolethane triglycidyl ether, trimethylolpropane triglycidyl ether, glycerol triglycidyl ether, triglycidyl tris-hydroxyethyl isocyanurate, sorbitol tetraglycidyl ether, pentaerythritol tetraglycidyl ether, cresol/novolak resin polyglycidyl ether, phenol/novolak resin polyglycidyl ether, etc.; alicyclic epoxy compounds such as Celoxide 2021P, Celoxide 2081, Epolead GT-301, Epolead GT-401, EHPE 3150CE (all by Daicel Chemical), phenol/novolak resin polycyclohexyl epoxymethyl ether, etc.; oxetanes such as OXT-121, OXT-221, OX-SQ, PNOX-1009 (all by To a Gosei), etc. In addition, also usable as the hard coat layer are polymer of glycidyl (meth)acrylate, or copolymer thereof with monomer copolymerizable with glycidyl(meth)acrylate.

It is also preferred to add to the hard coat layer, fine particles of oxide with silicon, titanium, zirconium, aluminium or the like, as well as crosslinked fine particles, for example, crosslinked organic fine particles of polyethylene, polystyrene, poly(meth)acrylate, polydimethylsiloxane, etc., or crosslinked rubber fine particles of SBR, NBR, etc., for the purpose of reducing the curing shrinkage of the layer, enhancing the adhesiveness of the layer to substrate and preventing the hard coat layer-having product in the invention from curling. Preferably, the mean particle size of these crosslinked fine particles is from 1 nm to 20000 nm. The shape of the crosslinked fine particles may be spherical, rod-like, needle-like or tabular with no specific limitation thereon. Preferably, the amount of the fine particles to be added is at most 60% by volume of the cured hard coat layer, more preferably at most 40% by volume.

In case where the inorganic fine particles mentioned above are added to the hard coat layer, it is desirable to treat the surfaces of the particles with a surface-treating agent that contains a metal such as silicon, aluminium, titanium or the like and has a functional group such as an alkoxide group, a carbonic acid group, a sulfonic acid group, a phosphonic acid group or the like, since the particles generally have poor affinity with binder polymer.

Preferably, the hard coat layer is cured by heat or active energy rays; and above all, more preferred is use of active energy rays such as radiation rays, gamma rays, alpha rays, electron beams, UV rays, etc. In consideration of safety and productivity, more preferred is use of electron beams or UV rays. In case where the layer is cured by heat, the heating temperature is preferably not higher than 140° C. in consideration of the heat resistance of the plastics themselves, more preferably not higher than 100° C.

### (Front Scattering Layer)

The front scattering layer is used for improving the viewing angle characteristics (color shift and brightness distribution) in all directions when the polarizer of the invention is applied to liquid-crystal display devices. In the invention, preferably, the front scattering layer is so designed that fine particles having a different refractive index are dispersed in a binder, for which, for example, employable are the configurations in JP-A 11-38208 where the front scattering coefficient is specifically defined, in JP-A 2000-199809 where the relative refractivity between transparent resin and fine particles is defined to fall within a specific range, in JP-A 2002-107512 where the haze value is defined to be at least 40%, etc. Also preferred is use of the polarizer of the invention as combined with “Lumisty” described in Sumitomo Chemical's Technical Report “Photofunctional Film”, pp. 31-39, for the purpose of controlling the viewing angle characteristics of haze.

### (Antiglare Layer)

The antiglare layer is used for preventing reflected light from scattering to cause glaring or background reflections. The antiglare function is attained by roughening the outermost surface (panel side) of liquid-crystal display devices. Preferably, the haze of the optical film having such an antiglare function is from 3 to 30%, more preferably from 5 to 20%, most preferably from 7 to 20%.

As the method of roughening the film surface, for example, preferred is a method of adding fine particles to the film to thereby roughen the film surface (for example, as in JP-A 2000-271878), a method of adding a small amount (from 0.1 to 50% by mass) of relatively large particles (having a particle size of from 0.05 to 2 μm) to thereby roughen the film surface (for example, as in JP-A 2000-281410, 2000-95893, 2001-100004, 2001-281407), a method of physically transferring irregularities onto the film surface (for example, as an embossing method, as in JP-A 63-278839, 11-183710, 2000-275401), etc.

### [Liquid-Crystal Display Device]

Next described is the liquid-crystal display device of the invention.

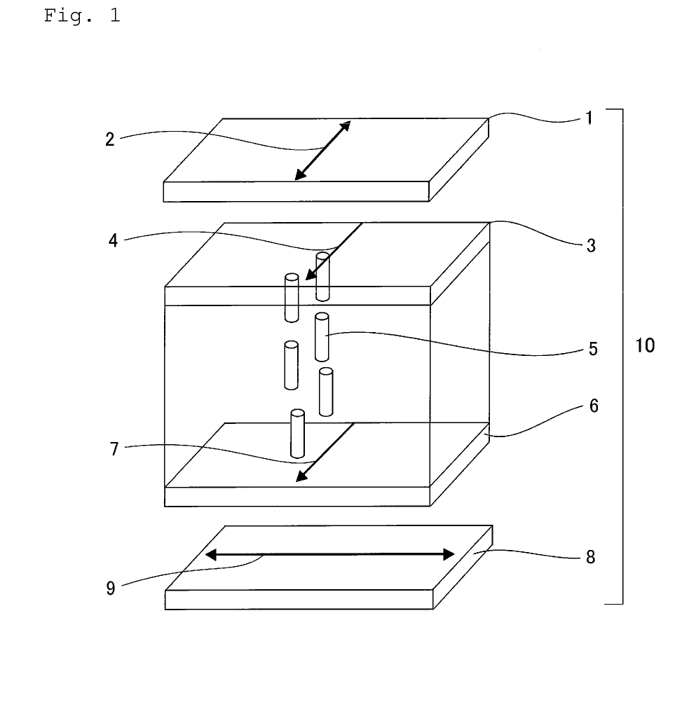

FIG. 1 is a schematic view showing an example of the liquid-crystal display device of the invention. In FIG. 1, the liquid-crystal display device 10 comprises a liquid-crystal cell that comprises the liquid-crystal layer 5 and, as arranged on and below the layer, the liquid-crystal cell upper electrode substrate 3 and the liquid-crystal cell lower electrode substrate 6, and the upper polarizer 1 and the lower polarizer 8 arranged on both sides of the liquid-crystal cell. A color filer may be arranged between the liquid-crystal cell and each polarizer. In case where the liquid-crystal display device 10 is a transmission-type device, a backlight with a light source of a cold cathode or hot cathode fluorescent tube, a light-emitting diode, a field emission element or an electroluminescent element is arranged on the back of the device.

The upper polarizer 1 and the lower polarizer 8 each are so laminated that the polarizing element therein is sandwiched between two protective films, and in the liquid-crystal display device 10 of the invention, preferably, the protective film on the liquid-crystal cell side of one polarizer has the characteristics of the above-mentioned formulae (1) to (4). Preferably, the liquid-crystal display device 10 of the invention is so designed that a transparent protective film, the polarizing element and the cellulose acylate film of the invention are laminated in that order from the outer side of the device (from the side remoter from the liquid-crystal cell).

The liquid-crystal display device 10 includes an image direct-viewing type, an image projection type and a light modulation type. The invention is effective for an active-matrix liquid-crystal display device that uses a 3-terminal or 2-terminal semiconductor device such as TFT or MIM. Needless-to-say, the invention is also effective for a passive-matrix liquid-crystal display device such as typically an STN mode referred to as a time-division driving system.

### (VA Mode)

Preferably, the liquid-crystal cell in the liquid-crystal display device of the invention is a VA-mode cell.

In the VA-mode cell, liquid-crystal molecules having a negative dielectric anisotropy and having Δn=0.813 and Δ∈=−4.6 or so are aligned by rubbing between the upper and lower substrates, and the director, or that is, the tilt angle that indicates the alignment direction of the liquid-crystal molecules is about 89°. In FIG. 1, the thickness d of the liquid-crystal layer 5 is preferably 3.5 μm or so. Depending on the level of the product Δnd of the thickness d and the refractivity anisotropy Δn, the brightness at the time of white level of display varies. Accordingly, for obtaining the maximum brightness, the thickness of the liquid-crystal layer is defined to fall within a range of from 0.2 μm to 0.5 μm.

The upper polarizer 1 and the lower polarizer 8 between which the liquid-crystal cell is sandwiched are so laminated that the absorption axis 2 of the former is nearly perpendicular to the absorption axis 9 of the latter. Inside the alignment film of each of the liquid-crystal cell upper electrode substrate 3 and the liquid-crystal cell lower electrode substrate 6, formed is a transparent electrode (not shown). In a non-driving condition where no driving voltage is applied to the electrode, the liquid-crystal molecules in the liquid-crystal layer 5 are aligned nearly perpendicularly to the substrate face, and therefore in the condition, the polarization condition of the light passing through the liquid-crystal panel changes little. Specifically, the liquid-crystal display device realizes an ideal black display in the non-driving condition. As opposed to this, in a driving condition, the liquid-crystal molecules are tilted in the direction parallel to the substrate face, and in this condition, the polarization condition of the light passing through the liquid-crystal panel is changed by the thus-tilted liquid-crystal molecules. In other words, the liquid-crystal display device presents a white display in the driving condition. In FIG. 1, the reference numerals 4 and 7 indicate the alignment control direction.

In the device, an electric field is applied between the upper and lower substrates, and therefore, preferred is use of a liquid-crystal material having a negative dielectric anisotropy in which the liquid-crystal molecules respond perpendicularly to the electric field direction. In case where an electrode is arranged on one substrate and where an electric field is applied in the lateral direction that is parallel to the substrate, a liquid-crystal material having a positive dielectric anisotropy is used.

In a VA-mode liquid-crystal display device, a chiral agent that is generally used in a TN-mode liquid-crystal display device is used little as degrading the dynamic responsive characteristic of the device, but may be used therein for reducing alignment failure.

The VA-mode device is characterized by high-speed response and high contrast. The VA-mode device may have a high contrast in the front direction but is problematic in that the contrast thereof worsens in oblique directions. At the time of black level of display, the liquid-crystal molecules are aligned perpendicularly to the substrate face. In this condition, when the device is seen in the front direction, there occurs little birefringence of the liquid-crystal molecules therein and therefore the transmittance is low and the contrast is high. However, when seen in oblique directions, there occurs birefringence of the liquid-crystal molecules in the device. Moreover, the crossing angle of the absorption axes of the upper and lower polarizers is 90°, or that is, the absorption axes of the two cross at right angles in the front direction; however, in oblique directions, the crossing angle is larger than 90°. Because of these two factors, there occurs light leakage in oblique directions and the contrast is thereby lowered. To solve this problem, the cellulose acylate film of the invention is disposed as an optically compensatory sheet (retardation film).

At the time of white level of display, the liquid-crystal molecules in the device are tilted, but in the direction opposite to the tilt direction, the birefringence level of the liquid-crystal molecules varies in oblique observation, therefore causing difference in brightness and color tone. To solve this problem, preferably employed is a multidomain structure in which one pixel of the liquid-crystal display device is divided into multiple regions.

### (Multidomain)

For example, in a VA system, the liquid-crystal molecules are given an electric field and are tilted in different multiple regions in one pixel whereby the viewing angle characteristics are averaged. For dividing the alignment in one pixel, a slit may be formed in the electrode or a projection may be formed therein to thereby change the electric field direction or change the electric field density in different sites. For obtaining uniform viewing angle characteristics in all directions, the number of divisions may be increased. For example, 4 divisions or 8 divisions or more may give almost uniform viewing angle characteristics. In particular, a 8-division system is preferred since the polarizer absorption axis can be defined in any desired angle therein.

In the alignment division region boundary, the liquid-crystal molecules hardly respond. Accordingly, in a normally black display, the black level of display can be maintained, therefore causing a problem of brightness depression. Accordingly, a chiral agent may be added to the liquid-crystal material to reduce the boundary region.

### EXAMPLES

The characteristics of the invention are described more concretely with reference to Examples and Comparative Examples given below. In the following Examples, the material used, its amount and ratio, the details of the treatment and the treatment process may be suitably modified or changed not overstepping the spirit and the scope of the invention. Accordingly, the invention should not be limitatively interpreted by the Examples mentioned below.

### Comparative Example 1

### [Production of Cellulose Acylate Film]

### (Preparation of Cellulose Acylate Solution)

The following ingredients were put into a mixing tank and dissolved by stirring to prepare a cellulose acylate solution 1.

Composition of Cellulose Acetate Solution 1

| | |
|---|---|
| Cellulose Acetate having a degree of acetyl | 100.0 parts by mass |
| substitution of 2.43 and a degree of polymerization | |
| of 340 | |
| Carbohydrate derivative 105 | 10.0 parts by mass |
| Methylene chloride (first solvent) | 402.0 parts by mass |
| Methanol (second solvent) | 60.0 parts by mass |

### (Preparation of Mat Agent Solution 2)

The following ingredients were put into a disperser and dissolved by stirring to prepare a mat agent solution 2.

Composition of Mat Agent Solution 2

| | |
|---|---|
| Silica particles having a mean particle size of 20 nm | 2.0 parts by mass |
| (AEROSIL R972, by Nippon Aerosil) | |
| Methylene chloride (first solvent) | 75.0 parts by mass |
| Methanol (second solvent) | 12.7 parts by mass |
| Cellulose acylate solution 1 mentioned above | 10.3 parts by mass |

1.3 parts by mass of the mat agent solution 2 and 98.7 parts by mass of the cellulose acylate solution 1 were mixed using an in-line mixer. The mixed solution was cast, using a band caster, and dried at 100° C. to have a residual solvent amount of 40%, and the film was peeled. The peeled film was dried at an atmospheric temperature of 140° C. for 20 minutes. After dried, the film was stretched by 35% in the direction perpendicular to the machine direction in an atmosphere at 180° C., thereby producing a cellulose acylate film of Comparative Example 1. The thickness of the produced cellulose acylate film was 50 μm.

### [Saponification Treatment of Cellulose Acylate Film]

Next, the produced cellulose acylate film of Comparative Example 1 was dipped in an aqueous solution of 2.3 mol/L sodium hydroxide at 55° C. for 3 minutes. This was washed in a water-washing bath at room temperature, and then neutralized with 0.05 mol/L sulfuric acid at 30° C. Again this was washed with a water-washing bath at room temperature and then dried with hot air at 100° C. Accordingly, the surface of the cellulose acylate film of Comparative Example 1 was saponified.

### [Production of Polarizer]

A stretched polyvinyl alcohol film was made to adsorb iodine to prepare a polarizing element.

Using a polyvinyl alcohol adhesive, the saponified cellulose acylate film of Comparative Example 1 was stuck to one side of the polarizing element. A commercially-available cellulose triacetate film (Fujitac TD80UF by FUJIFILM) was saponified in the same manner as above, and using a polyvinyl alcohol adhesive, the thus-saponified cellulose triacetate film was stuck to the other side of the polarizing element to which the cellulose acylate film of Comparative Example 1 had been stuck.

In this, the polarizing element and the cellulose acylate film of Comparative Example 1 were so arranged that the transmission axis of the former could be parallel to the slow axis of the latter. In addition, the polarizing element and the commercially-available cellulose triacetate film were also so arranged that the transmission axis of the former could be perpendicular to the slow axis of the latter.

In that manner, a polarizer of Comparative Example 1 was produced.

### Examples 1 to 8

### Comparative Examples 2 to 13

### [Production of Cellulose Acylate Film]

Cellulose acylate films of Examples 1 to 8 and Comparative Examples 2 to 13 were produced in the same manner as in Comparative Example 1, except that the degree of substitution of the cellulose acetate, the type and the amount of the carbohydrate derivative, the stretching temperature, the draw ratio in stretching and the film thickness in Comparative Example 1 were changed as in Table 5 below.

In the following Table 5, the amount of the carbohydrate derivative is in terms of part by mass relative to 100 parts by mass of the cellulose acylate resin.

### [Saponification Treatment of Cellulose Acylate Film and Production of Polarizer]

The cellulose acylate films of Examples 1 to 8 and Comparative Examples 2 to 13 were separately saponified and used for polarizer production in the same manner as in Comparative Example 1, thereby producing polarizers of Examples 1 to 8 and polarizers of Comparative Examples 2 to 13.

### <Evaluation>

### (Determination of Water Content)

A sample, 7 mm×35 mm of the cellulose acylate film of Examples and Comparative Examples produced in the manner as above was conditioned in an environment at 25° C. and at a relative humidity of 80% for 2 hours or more, and then analyzed using a moisture content meter and a sample drier (CA-03, VA-05, both by Mitsubishi Chemical) and according to a Karl-Fischer method. The amount of water (g) was divided by the weight of the sample (g) to give the water content of the film. The obtained results are shown in Table 5 below.

### (Determination of Retardation)

The cellulose acylate film of Examples and Comparative Examples was analyzed for Re and Rth thereof at a wavelength of 446 nm, 548 nm and 629 nm, at 25° C. and at a relative humidity of 60%, using an automatic birefringence meter (KOBRA-WR, by Oji Scientific Instruments). In the following Table 5, the value of Re (548 nm) is given in the column Re, the value of Re (629 nm)-Re (446 nm) is given in the column ΔRe (629-446), and the value of Re (548 nm) is given in the column of Rth.

### (Measurement of Haze)

A sample, 40 mm×80 mm of the cellulose acylate film of Examples and Comparative Examples was analyzed using a haze meter (HGM-2DP, by Suga Scientific Instruments) in an atmosphere at 25° C. and at a relative humidity of 60% according to JIS K-6714. The obtained results are shown in Table 5 below.

### (Evaluation of Polarizer Durability)

The polarizers of Examples 1 to 10 and Comparative Examples 1 to 14 produced in the above were analyzed for the cross transmittance thereof at a wavelength of 410 nm, according to the method described hereinabove.

Next, the polarizers of Examples 1 to 6 and Comparative Examples 1 to 7, 12 and 13 were stored in an environment at 60° C. and at a relative humidity of 95% for 7 days, and their cross transmittance was measured. The cross transmittance change before and after the storage was computed according to the method described hereinabove. The results are shown as the polarizer durability after 7 days storage in Table 5 below.

On the other hand, the polarizers of Example 7 and Comparative Examples 8 and 9 were stored in an environment at 60° C. and at a relative humidity of 90% for 14 days, and their cross transmittance was measured. Similarly, the cross transmittance change before and after the storage was computed. The results are shown as the polarizer durability after 14 days storage in Table 5 below.

Further, the polarizers of Example 8 and Comparative Examples 10 and 11 were stored in an environment at 60° C. and at a relative humidity of 90% for 21 days, and their cross transmittance was measured. Similarly, the cross transmittance change before and after the storage was computed. The results are shown as the polarizer durability after 21 days storage in Table 5 below. In the following Table 5, in Comparative Example 13, the film transparency greatly lowered and therefore the retardation, the polarizer durability and the cross transmittance thereof could not be determined.

TABLE 5

| | | | | | | | | | | | | | | | | | | | | | | | Polarizer | | |
|---|---|---|---|---|---|---|---|---|---|---|---|---|---|---|---|---|---|---|---|---|---|---|---|---|---|
| | | | | Carbohydrate Derivative | | | | | | | | | | | | | | | | | | | Properties | | |
| | Degree | | | | | aromatic | | | | | | | | | | | | | | | | | polarizer | | |
| | of Acyl Sub- | | | | | ring- | | | | | | | | | | | | | | | | | durability: | | |
| | stitution of | | | | | containing | | other | | number | | | | | Stretching | | | | Film Properties | | | | cross | | |
| | Cellulose | | | | | substituent | | substituent | | of hy- | | | | a- | Condition | | | wa- | optical properties | | | | transmittance | | |
| | Acylate | | | | | | degree | | degree | droxyl | | mo- | ε | mount | tem- | | | ter | | ARe | | | change (%) | | |
| | | pro- | | | moose | | of | | of | groups/ | | lecu- | maxi- | added | pera- | draw | thick- | con- | | (629- | | | 7 | 14 | 21 |
| | ace- | pio- | to- | | struc- | | substi- | | substi- | mo- | Clog | lar | mum | (mas. | ture | ratio | ness | tent | Re | 446) | Rth | haze | days | days | days |
| | tyl | nyl | tal | type | ture | type | tution | type | tution | nose | P | weight | value | pt.) | (° C.) | (%) | (μm) | (%) | (nm) | (nm) | (nm) | (%) | storage | storage | storage |
| Compa- | 2.43 | 0 | 2.43 | 105 | pyra- | benz- | 2 | none | — | 3 | 0.6 | 523 | less | 10 | 180 | 35 | 50 | 5.0 | 50 | 7.2 | 122 | 0.55 | 0.10 | — | — |
| rative | | | | | nose + | yl | | | | | | | than | | | | | | | | | | | | |
| Example | | | | | fura- | | | | | | | | 1 × 10³ | | | | | | | | | | | | |
| 1 | | | | | nose | | | | | | | | | | | | | | | | | | | | |
| Example | 2.43 | 0 | 2.43 | 201 | pyra- | benz- | 1 | acetyl | 4 | 0 | 2.2 | 468 | 17 × | 10 | 180 | 35 | 50 | 4.7 | 48 | 6.3 | 110 | 0.48 | 0.05 | — | — |
| 1 | | | | | nose | oyl | | | | | | | 10³ | | | | | | | | | | | | |
| Example | 2.43 | 0 | 2.43 | 202 | pyra- | benz- | 2 | acetyl | 3 | 0 | 3.9 | 514 | 33 × | 10 | 180 | 35 | 50 | 4.4 | 53 | 5.5 | 120 | 0.37 | 0.04 | — | — |
| 2 | | | | | nose | oyl | | | | | | | 10³ | | | | | | | | | | | | |
| Example | 2.43 | 0 | 2.43 | 203 | pyra- | benz- | 3 | acetyl | 2 | 0 | 5.4 | 577 | 49 × | 10 | 180 | 35 | 50 | 4.5 | 58 | 4.8 | 141 | 0.55 | 0.03 | — | — |
| 3 | | | | | nose | oyl | | | | | | | 10³ | | | | | | | | | | | | |
| Compa- | 2.43 | 0 | 2.43 | 203 | pyra- | benz- | 3 | acetyl | 2 | 0 | 5.4 | 577 | 49 × | 0.5 | 180 | 35 | 50 | 6.6 | 40 | 8.0 | 130 | 0.6 | 0.17 | — | — |
| rative | | | | | nose | oyl | | | | | | | 10³ | | | | | | | | | | | | |
| Example | | | | | | | | | | | | | | | | | | | | | | | | | |
| 12 | | | | | | | | | | | | | | | | | | | | | | | | | |
| Compa- | 2.43 | 0 | 2.43 | 203 | pyra- | benz- | 3 | acetyl | 2 | 0 | 5.4 | 577 | 49 × | 31 | 180 | 35 | 50 | 3.6 | — | — | — | 55 | — | — | — |
| rative | | | | | nose | oyl | | | | | | | 10³ | | | | | | | | | | | | |
| Example | | | | | | | | | | | | | | | | | | | | | | | | | |
| 13 | | | | | | | | | | | | | | | | | | | | | | | | | |
| Example | 2.43 | 0 | 2.43 | 205 | pyra- | benz- | 2 | acetyl | 3 | 0 | 3.8 | 489 | less | 10 | 180 | 35 | 50 | 4.4 | 53 | 6.7 | 132 | 0.35 | 0.04 | — | — |
| 4 | | | | | nose | yl | | | | | | | than | | | | | | | | | | | | |
| | | | | | | | | | | | | | 1 × 10³ | | | | | | | | | | | | |
| Example | 2.43 | 0 | 2.43 | 208 | pyra- | phe- | 2 | acetyl | 3 | 0 | 3.8 | 543 | less | 10 | 180 | 35 | 50 | 4.4 | 5.0 | 6.6 | 130 | 0.36 | 0.04 | — | — |
| 5 | | | | | nose | nyl- | | | | | | | than | | | | | | | | | | | | |
| | | | | | | acetyl | | | | | | | 1 × 10³ | | | | | | | | | | | | |
| Compa- | 2.43 | 0 | 2.43 | 211 | pyra- | phe- | 2 | none | — | 3 | 2.0 | 416 | less | 10 | 180 | 35 | 50 | 4.7 | 49 | 6.4 | 122 | 0.33 | 0.06 | — | — |
| rative | | | | | nose | nyl | | | | | | | than | | | | | | | | | | | | |
| Ex- | | | | | | acetyl | | | | | | | 1 × 10³ | | | | | | | | | | | | |
| ample 2 | | | | | | | | | | | | | | | | | | | | | | | | | |
| Example | 2.43 | 0 | 2.43 | 303 | pyra- | phe- | 2 | acetyl | 6 | 0 | 4.3 | 831 | less | 10 | 180 | 35 | 50 | 4.5 | 50 | 6.5 | 127 | 0.5 | 0.05 | — | — |
| 6 | | | | | nose + | nyl- | | | | | | | than | | | | | | | | | | | | |
| | | | | | pyra- | ace- | | | | | | | 1 × 10³ | | | | | | | | | | | | |
| | | | | | nose | yyl | | | | | | | | | | | | | | | | | | | |
| Compa- | 2.43 | 0 | 2.43 | 404 | pyra- | ben- | 2 | none | — | 3 | 0.7 | 551 | 15 × | 10 | 180 | 35 | 50 | 5.0 | 50 | 5.4 | 116 | 0.58 | 0.11 | — | — |
| rative | | | | | nose + | oyl | | | | | | | 10³ | | | | | | | | | | | | |
| Example | | | | | pyra- | | | | | | | | | | | | | | | | | | | | |
| 3 | | | | | nose | | | | | | | | | | | | | | | | | | | | |
| Compa- | 2.43 | 0 | 2.43 | com- | pyra- | none | — | acetyl | 5 | 0 | −0.10 | 390 | less | 10 | 180 | 35 | 50 | 5.3 | 41 | 7.0 | 101 | 0.60 | 0.14 | — | — |
| rative | | | | pound | nose | | | | | | | | than | | | | | | | | | | | | |
| Example | | | | C | | | | | | | | | 1 × 10³ | | | | | | | | | | | | |
| 4 | | | | | | | | | | | | | | | | | | | | | | | | | |
| Compa- | 2.43 | 0 | 2.43 | com- | pyra- | none | — | pro- | 5 | 0 | 5.73 | 391 | less | 10 | 180 | 35 | 50 | 5.2 | 42 | 7.1 | 105 | 0.50 | 0.15 | — | — |
| rative | | | | pound | nose | | | pionyl | | | | | than | | | | | | | | | | | | |
| Example | | | | A | | | | | | | | | 1 × 10³ | | | | | | | | | | | | |
| 5 | | | | | | | | | | | | | | | | | | | | | | | | | |
| Compa- | 2.43 | 0 | 2.43 | com- | pen- | benz- | 3 | none | — | 1 | 4.1 | 462 | 52 × | 10 | 180 | 35 | 50 | 4.6 | 58 | 4.8 | 131 | 0.40 | 0.06 | — | — |
| rative | | | | pound | tose | oyl | | | | | | | 10³ | | | | | | | | | | | | |
| Example | | | | D-2 | | | | | | | | | | | | | | | | | | | | | |
| 6 | | | | | | | | | | | | | | | | | | | | | | | | | |
| Compa- | 2.43 | 0 | 2.43 | com- | pyra- | benz- | 2 | t-butyl | 1 | 1 | 5.7 | 507 | less | 10 | 180 | 35 | 50 | 5.1 | 58 | 6.1 | 153.3 | 1.00 | 0.08 | — | — |
| rative | | | | pound | nose | yl | | p- | | | | | than | | | | | | | | | | | | |
| Example | | | | B | | | | methyl- | 1 | | | | 1 × 10³ | | | | | | | | | | | | |
| 7 | | | | | | | | hydro- | | | | | | | | | | | | | | | | | |
| | | | | | | | | quinone | | | | | | | | | | | | | | | | | |
| Example | 2.78 | 0 | 2.78 | 202 | pyra- | benz- | 2 | acetyl | 3 | 0 | 3.9 | 514 | 33 × | 15 | 160 | 30 | 78 | 2.6 | 17 | 7.7 | 120 | 0.33 | — | — | 0.12 |
| 7 | | | | | nose | oyl | | | | | | | 10³ | | | | | | | | | | | | |
| Compa- | 2.78 | 0 | 2.78 | com- | pyra- | none | — | acetyl | 5 | 0 | −0.10 | 390 | less | 15 | 160 | 30 | 78 | 3.3 | 6 | 9.2 | 90 | 0.31 | — | — | 0.20 |
| rative | | | | pound | nose | | | | | | | | than | | | | | | | | | | | | |
| Example | | | | C | | | | | | | | | 1 × 10³ | | | | | | | | | | | | |
| 8 | | | | | | | | | | | | | | | | | | | | | | | | | |
| Compa- | 2.78 | 0 | 2.78 | com- | pyra- | benz- | 8 | none | — | 0 | 12.2 | 1175 | 65 × | 15 | 160 | 30 | 78 | 3.5 | 14 | 6.3 | 115 | 0.56 | — | — | 0.22 |
| rative | | | | pound | nose + | oyl | | | | | | | 10³ | | | | | | | | | | | | |
| Example | | | | E | fura- | | | | | | | | | | | | | | | | | | | | |
| 9 | | | | | nose | | | | | | | | | | | | | | | | | | | | |
| Example | 1.5 | 0.9 | 2.40 | 202 | pyra- | benz- | 2 | acetyl | 3 | 0 | 3.9 | 514 | 33 × | 13 | 170 | 40 | 41 | 3.0 | 55 | 118 | 4.2 | 0.22 | — | 0.06 | — |
| 8 | | | | | nose | oyl | | | | | | | 10³ | | | | | | | | | | | | |
| Compa- | 1.5 | 0.9 | 2.40 | com- | pyra- | none | — | acetyl | 5 | 0 | −0.10 | 390 | less | 6 | 170 | 40 | 41 | 3.7 | 45 | 98 | 4.5 | 0.32 | — | 0.11 | — |
| rative | | | | pound | nose | | | | | | | | than | | | | | | | | | | | | |
| Example | | | | C | | | | | | | | | 1 × 10³ | | | | | | | | | | | | |
| 10 | | | | | | | | | | | | | | | | | | | | | | | | | |
| Compa | 1.5 | 0.9 | 2.40 | com- | pyra- | benz- | 8 | none | — | 0 | 12.2 | 1175 | 65 × | 6 | 170 | 40 | 41 | 3.5 | 50 | 115 | 3.5 | 0.30 | — | 0.09 | — |
| rative - | | | | pound | nose + | oyl | | | | | | | 10³ | | | | | | | | | | | | |
| Example | | | | E | fura- | | | | | | | | | | | | | | | | | | | | |
| 11 | | | | | nose | | | | | | | | | | | | | | | | | | | | |

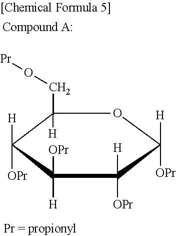

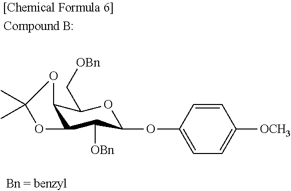

Compound C: penta-O-acetyl-β-D-glucopyranoside.
Compound D-2: exemplary compound D-2 in WO2009-011229.
Compound E: saccharose octabenzoate.

Further, Examples 7 and 8 and Comparative Examples 8 to 11 were tested for polarizer durability after aged for 7 days. It has been known that the change was at most 0.05% in Examples 7 and 8 and was more than 0.05% in Comparative Examples 8 to 11.

From the results in the above Table 5, it is known that the cellulose acylate films of the invention using a specific carbohydrate derivative satisfying the conditions defined in the invention are good as having a low water content, having good optical characteristics expressibility and having a low haze. Further, it is known that the polarizers using the cellulose acylate film of the invention hardly deteriorate after aged in high-temperature and high-humidity environments.

On the other hand, the following tendency is known in Comparative Examples 1 to 9 using the same cellulose acylate as that in Examples 1 to 6. Concretely, in Comparative Examples 1 to 3 in which a carbohydrate derivative having only one type of an aromatic ring-containing substituent, the polarizer durability level is more than 0.05% after aged for 7 days. In Comparative Examples 4 and 5 in which a carbohydrate derivative having only one type of an aromatic ring-free substituent and having a Clog P value falling outside the scope of the invention is added, the water content of the films is high and, in addition, the polarizer durability level is more than 0.05% after aged for 7 days. In Comparative Example 6 in which a carbohydrate derivative having only one type of an aromatic ring-containing substituent and having the maximum value c that falls outside the scope of the invention is added, the polarizer durability level is more than 0.05% after aged for 7 days. In Comparative Example 7 in which a carbohydrate derivative having three types of aromatic ring-free substituents and having a Clog P value falling outside the scope of the invention is added, the water content of the film is high, the haze is high and the polarizer durability level is more than 0.05% after aged for 7 days.

In addition, it is known that, in Comparative Example 12 in which the amount of the specific carbohydrate derivative satisfying the conditions defined in the invention is smaller than the range defined in the invention, the water content of the film is high. It is also known from Comparative Example 13 that, when the amount of the specific carbohydrate derivative satisfying the conditions defined in the invention is larger than the range defined in the invention, then the water content of the film is high.

### [Production of Liquid-Crystal Display Device]

Two polarizers were peeled away from a commercially-available liquid-crystal television (SONY's Bravia J5000), and the polarizer of the invention comprising the cellulose acylate film of Example 2 was stuck to the viewers' side and the backlight side of the device, using an adhesive, in such a manner that the cellulose acylate film of Example 2 could face the liquid-crystal cell in the device. Thus, one polarizer was stuck each to the viewers' side and the backlight side of the device. In this, the transmission axis of the viewers' side polarizer was set in the vertical direction while the transmission axis of the backlight side polarizer was in the horizontal direction, thus in cross-Nicol configuration. Thus produced, the liquid-crystal display devices of the invention are good in that, even when the environmental humidity is changed and even when the devices are watched in oblique directions, the contrast change and the color shift are both small, and in addition, even when the devices are used in high-temperature and high-humidity environments for a long time, the contrast depression thereof is small.

### Comparative Example 14

### [Production of Cellulose Acylate Film]

### (Preparation of Cellulose Acylate Solution)

The following ingredients were put into a mixing tank and dissolved by stirring to prepare a cellulose acylate solution 4.

Composition of Cellulose Acetate Solution 4

| | |
|---|---|
| Cellulose Acetate having a degree of acetyl | 100.0 parts by mass |
| substitution of 2.39 and a degree of polymerization | |
| of 400 | |
| Carbohydrate derivative 215 | 2.0 parts by mass |
| Methylene chloride (first solvent) | 425.0 parts by mass |
| Methanol (second solvent) | 48.0 parts by mass |

### (Preparation of Mat Agent Solution 5)

The following ingredients were put into a disperser and dissolved by stirring to prepare a mat agent solution 2.

Composition of Mat Agent Solution 5

| | |
|---|---|
| Silica particles having a mean particle size of 20 nm | 7.0 parts by mass |
| (AEROSIL R972, by Nippon Aerosil) | |
| Methylene chloride (first solvent) | 80.7 parts by mass |
| Methanol (second solvent) | 10.2 parts by mass |
| Cellulose acylate solution 4 mentioned above | 5.3 parts by mass |

1.3 parts by mass of the mat agent solution 5 and 98.7 parts by mass of the cellulose acylate solution 4 were mixed using an in-line mixer. The mixed solution was cast, using a band caster, and dried at 80° C. to have a residual solvent amount of 30%, and the film was peeled. Using a tenter stretcher, the he peeled film was stretched by 30% in the direction perpendicular to the machine direction, in an atmosphere at 150° C., thereby producing a cellulose acylate film of Comparative Example 14. The thickness of the produced cellulose acylate film was 40 μm.

### Examples 9 to 12

### [Production of Cellulose Acylate Film]

Cellulose acylate films of Examples 9 to 12 were produced in the same manner as in Comparative Example 14, except that the type and the amount of the carbohydrate derivative in Comparative Example 14 were changed as in Table 6 below. In the following Table 6, the amount of the carbohydrate derivative is in terms of the ratio (% by mass) thereof to cellulose acylate.

(Measurement of Haze after Aged in High-Temperature and High-Humidity Environments)

A sample, 40 mm×80 mm of the cellulose acylate film of Examples 9 to 12 and Comparative Example 14 was, after stored at 80° C. and at a relative humidity of 90% for 7 days, analyzed using a haze meter (HGM-2DP, by Suga Scientific Instruments) in an atmosphere at 25° C. and at a relative humidity of 60% according to JIS K-6714. The obtained results are shown in Table 6 below.

TABLE 6

| | | | | Carbohydrate Derivative | | | | | |
|---|---|---|---|---|---|---|---|---|---|
| | | | | | | aromatic ring- | | | |
| | Degree of Acyl | | | | | containing | | other | |
| | Substitution of | | | | | substituent | | substituent | |
| | Cellulose Acylate | | | | mouse | | degree of | | degree of |
| | acetyl | propionyl | total | type | structure | type | substitution | type | substitution |
| Comparative | 2.39 | 0 | 2.39 | 215 | pyranose | benzoyl | 5 | acetyl | 0 |
| Example 14 | | | | | | | | | |
| Example 9 | 2.39 | 0 | 2.39 | 203 | pyranose | benzoyl | 3 | acetyl | 2 |
| Example 10 | 2.39 | 0 | 2.39 | 202 | pyranose | benzoyl | 2 | acetyl | 3 |
| | | | | 203 | pyranose | benzoyl | 3 | acetyl | 2 |
| | | | | 215 | pyranose | benzoyl | 5 | acetyl | 0 |
| Example 11 | 2.39 | 0 | 2.39 | compound | pyranose | none | — | acetyl | 5 |
| | | | | C | | | | | |
| | | | | 201 | pyranose | benzoyl | 1 | acetyl | 4 |
| | | | | 202 | pyranose | benzoyl | 2 | acetyl | 3 |
| | | | | 203 | pyranose | benzoyl | 3 | acetyl | 2 |
| | | | | 214 | pyranose | benzoyl | 4 | acetyl | 1 |
| | | | | 215 | pyranose | benzoyl | 5 | acetyl | 0 |
| Example 12 | 2.39 | 0 | 2.39 | 202 | pyranose | benzoyl | 2 | acetyl | 3 |
| | | | | 214 | pyranose | benzoyl | 4 | acetyl | 1 |

| | Carbohydrate Derivative | | | | | | Stretching | |
|---|---|---|---|---|---|---|---|---|
| | number of | | | | | | Condition | |
| | hydroxyl | | | ε | amount | mean | | draw |
| | groups/ | Clog | molecular | maximum | added | Clog | temperature | ratio |
| | monose | P | weight | value | (mas. pt.) | P | (° C.) | (%) |
| Comparative | 0 | 8.3 | 701 | 60 × 10³ | 2.0 | 8.3 | 150 | 30 |
| Example 14 | | | | | | | | |
| Example 9 | 0 | 5.4 | 577 | 40 × 10³ | 10.0 | 5.4 | 150 | 30 |
| Example 10 | 0 | 3.9 | 514 | 30 × 10³ | 3.7 | 5.4 | 150 | 30 |
| | 0 | 5.4 | 577 | 40 × 10³ | 4.3 | | | |
| | 0 | 8.3 | 701 | 60 × 10³ | 2.0 | | | |
| Example 11 | 0 | −0.10 | 390 | less than | 0.5 | 4.2 | 150 | 30 |
| | | | | 1 × 10³ | | | | |
| | 0 | 2.2 | 468 | 17 × 10³ | 2 | | | |
| | 0 | 3.9 | 514 | 30 × 10³ | 3.2 | | | |
| | 0 | 5.4 | 577 | 40 × 10³ | 3.3 | | | |
| | 0 | 6.4 | 639 | 51 × 10³ | 0.7 | | | |
| | 0 | 8.3 | 701 | 60 × 10³ | 0.2 | | | |
| Example 12 | 0 | 3.9 | 514 | 30 × 10³ | 4.0 | 5. 4 | 150 | 30 |
| | 0 | 6.4 | 639 | 51 × 10³ | 6.0 | | | |

| | | | | | | | Polarizer |
|---|---|---|---|---|---|---|---|
| | | | | | | | Properties |
| | | | | | | | polarizer |
| | | | | | | | durability: |
| | | | | | | | cross |
| | Film Properties | | | | | | transmittance |
| | | | optical properties | | | | change (%) |
| | | water | | ΔRe | | | 80° C., relative |
| | thickness | content | Re | (629-446) | Rth | haze | humidity 95% |
| | (μm) | (%) | (nm) | (nm) | (nm) | (%) | 7 days storage |
| Comparative | 40 | 6.7 | 28 | 4.8 | 100 | 7 | 5.60 |
| Example 14 | | | | | | | |
| Example 9 | 40 | 5.1 | 31 | 4.9 | 96 | 0.3 | 2.20 |
| Example 10 | 40 | 4.9 | 31 | 4.8 | 97 | 0.2 | 0.40 |
| Example 11 | 40 | 4.9 | 31 | 4.8 | 97 | 0.15 | 0.20 |
| Example 12 | 40 | 5.2 | 30 | 4.8 | 99 | 3.0 | 3.50 |

From the results in Table 6, it is known that the films of Examples 9 to 12 in which the mean Clog P value satisfies the range defined in the invention are good in that the water content is low, that the optical characteristics expressibility is good and that, in addition, the haze of the films after stored at 80° C. and at a relative humidity of 90% for 7 days is low. In particular, it is known that the films of Example 10 and Example 11, in which carbohydrate derivatives usable singly in the invention and differing in point of the substituent introduction ratio therein are mixed, are especially good in that the haze of the films is further smaller than that of the film in Example 9 in which only one type of the carbohydrate derivative having the same substituent introduction ratio is added. On the other hand, it is known that, in Example 12 in which the carbohydrate derivative usable singly in the invention and the other carbohydrate derivative than the carbohydrate derivative usable singly in the invention are used as combined, as multiple carbohydrate derivatives differing in point of the substituent introduction ratio therein, the evaluation of the film is on the middle level between the film in Comparative Example 9 and that in Example 9.

### DESCRIPTION OF REFERENCE NUMERALS

1 Upper Polarizer
2 Direction of Absorption Axis of Upper Polarizer
3 Liquid-Crystal Cell Upper Electrode Substrate
4 Upper Substrate Alignment Control Direction
5 Liquid-Crystal Layer
6 Liquid-Crystal Cell Lower Electrode Substrate
7 Lower Substrate Alignment Control Direction
8 Lower Polarizer
9 Direction of Absorption Axis of Lower Polarizer
10 Liquid-Crystal Display Device

1. A cellulose acylate film containing a cellulose acylate and a carbohydrate derivative satisfying the following conditions (a) and (b), wherein the hydroxyl groups in the carbohydrate derivative are substituted with at least two types of substituents and at least one of the substituents has at least one aromatic ring, and wherein the carbohydrate derivative is contained in an amount of from 1 part by mass to 30 parts by mass relative to 100 parts by mass of the cellulose acylate therein:
Condition (a):
the Clog P value thereof is from 0 to 5.5,
Condition (b):
the maximum value of the molar extinction coefficient thereof in a wavelength range of from 230 nm to 700 nm is at most 50×10³.

2. The cellulose acylate film according to claim 2, wherein the number of the hydroxyl groups contained in the carbohydrate derivative is at most 1 per monose unit of the carbohydrate derivative.

3. The cellulose acylate film according to claim 1, wherein the carbohydrate derivative has a structure represented by the following general formula (1):
(OH)p-G-(L1-R1)q(L2-R2)r General Formula (1)
wherein G represents a monose residue or a polyose residue;
L1 and L2 each independently represent any of —O—, —CO—, —NR3-;
R1, R2 and R3 each independently represent a hydrogen atom or a monovalent substituent;
at least one of R1 and R2 has an aromatic ring;
p indicates an integer of 0 or more;
q and r each independently indicate an integer of 1 or more;
p+q+r is equal to the number of the hydroxyl groups on the presumption that G is an unsubstituted sugar group having a cyclic acetal structure.

4. The cellulose acylate film according to claim 1, wherein the substituent of the hydroxyl group in the carbohydrate derivative is selected from a substituted or unsubstituted acyl group, a substituted or unsubstituted alkyl group, a substituted or unsubstituted aryl group, or a substituted or unsubstituted amino group.

5. The cellulose acylate film according to claim 1, wherein the substituent of the hydroxyl group in the carbohydrate derivative contains at least one substituent not containing an aromatic ring.

6. The cellulose acylate film according to claim 5, wherein the substituent not containing an aromatic ring of the hydroxyl group in the carbohydrate derivative contains at least one acetyl group.

7. The cellulose acylate film according to claim 1, wherein the substituent of the hydroxyl group in the carbohydrate derivative contains at least one benzyl group.

8. The cellulose acylate film according to claim 1, wherein the substituent of the hydroxyl group in the carbohydrate derivative contains at least one phenylacetyl group.

9. The cellulose acylate film according to claim 1, containing at least two types of carbohydrate derivatives differing in point of the substituent introduction ratio therein.

10. A retardation film containing a cellulose acylate film containing a cellulose acylate and a carbohydrate derivative satisfying the following conditions (a) and (b), wherein the hydroxyl groups in the carbohydrate derivative are substituted with at least two types of substituents and at least one of the substituents has at least one aromatic ring, and wherein the carbohydrate derivative is contained in an amount of from 1 part by mass to 30 parts by mass relative to 100 parts by mass of the cellulose acylate therein:
Condition (a):
the Clog P value thereof is from 0 to 5.5,
Condition (b):
the maximum value of the molar extinction coefficient thereof in a wavelength range of from 230 nm to 700 nm is at most 50×10³.

11. A polarizer containing a cellulose acylate film containing a cellulose acylate and a carbohydrate derivative satisfying the following conditions (a) and (b), wherein the hydroxyl groups in the carbohydrate derivative are substituted with at least two types of substituents and at least one of the substituents has at least one aromatic ring, and wherein the carbohydrate derivative is contained in an amount of from 1 part by mass to 30 parts by mass relative to 100 parts by mass of the cellulose acylate therein:
Condition (a):
the Clog P value thereof is from 0 to 5.5,
Condition (b):
the maximum value of the molar extinction coefficient thereof in a wavelength range of from 230 nm to 700 nm is at most 50×10³.

12. A liquid-crystal display device containing a cellulose acylate film containing cellulose acylate and a carbohydrate derivative satisfying the following conditions (a) and (b), wherein the hydroxyl groups in the carbohydrate derivative are substituted with at least two types of substituents and at least one of the substituents has at least one aromatic ring, and wherein the carbohydrate derivative is contained in an amount of from 1 part by mass to 30 parts by mass relative to 100 parts by mass of the cellulose acylate therein:
Condition (a):
the Clog P value thereof is from 0 to 5.5,
Condition (b):
the maximum value of the molar extinction coefficient thereof in a wavelength range of from 230 nm to 700 nm is at most 50×10³.
